(19) United States
(12) Patent Application Publication
(10) Pub. No.: US 2008/0049373 A1
(43) Pub. Date: Feb. 28, 2008

(54) High voltage output device and ion generator provided therewith

(75) Inventors: Masakazu Ikeda, Kizugawa-shi (JP); Masayuki Ehiro, Osaka (JP); Atsushi Yamashita, Kizugawa-shi (JP); Shinichi Yoshida, Nara-shi (JP); Manabu Yumoto, Nara-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/826,757

(22) Filed: Jul. 18, 2007

(30) Foreign Application Priority Data
Jul. 19, 2006 (JP) 2006-197115
Nov. 22, 2006 (JP) 2006-315255
Mar. 30, 2007 (JP) 2007-095333

(51) Int. Cl. H01J 3/04

(52) U.S. Cl. 361/231

(57) ABSTRACT

A high voltage output device in accordance with the present invention, which comprises a transformer that amplifies a voltage being fed to a primary side coil thereof so as to be produced from a secondary side coil thereof, and in which an alternate current input voltage is fed from the primary side coil, and an output voltage is taken out from the secondary side coil, further comprises a feedback circuit that feeds back the output voltage, and a voltage amplifying circuit that amplifies the voltage being fed back so as to be fed to the primary side coil. As a result, it is possible to provide such a high voltage output device as can obtain an output voltage efficiently, although a load capacity on a secondary side of a transformer fluctuates.

### CROSS-REFERENCE TO RELATED APPLICATIONS

This application is based on Patent Application No. 2006-197115 being filed in Japan on Jul. 19, 2006, Patent Application No. 2006-315255 being filed in Japan on Nov. 22, 2006 and Patent Application No. 2007-095333 being filed in Japan on Mar. 30, 2007, the entire contents of which are hereby incorporated by reference.

### BACKGROUND OF THE INVENTION

1. Field of the Invention

The present invention relates to a high voltage output device that produces a high voltage by employing a transformer, and relates to an ion generator being provided with such a high voltage output device as has been mentioned. The present invention also relates to an electronic apparatus and the like being provided with such an ion generator.

2. Description of the Prior Art

Conventionally, in order to improve health and eliminate various bacteria from the atmosphere, there have been developed ion generators that generate negative ions or positive ions in the atmosphere. These ion generators are installed to air purifiers, air conditioners, vacuum cleaners and the like.

The negative ions indicate substances having positive charges among atmospheric ions that exist in the atmosphere as a medium of electric current. It is known that there exist a large amount of negative ions near waterfalls, forests and the like, bringing a refreshing effect on body and mind. The positive ions have very small airborne materials in the air charged positively by being in contact with them, so that the positive ions are employed for an application of dust collection. In addition, when the ions are generated, ozone is produced by increasing an applied voltage to be high, and it is known that the ozone has a bactericidal action.

For example, in the Patent Application Laid-Open No. 2004-311158, a negative ion generator is disclosed. FIG. 18 shows a circuit diagram of a high voltage generating circuit in the ion generator.

In a circuit shown in FIG. 18, transistors Q1 and Q2 are switched over by an output from an oscillation circuit MV that employs a direct current power source as a source of operation, and an electric current on a primary side of a pulse transformer PT is disconnected. In addition, a high voltage that is produced in a secondary side coil N2 is amplified by a voltage doubler rectifyier circuit. Then, at an edge of a negative discharging electrode having a negative high voltage, being obtained by a voltage amplification, applied thereto, a corona discharge is produced, and as a result, a negative ion is generated. A voltage waveform passing through the voltage doubler rectifier circuit serves as a negative pulsating flow that is damped, following a positive pulse.

In a configuration as shown in FIG. 18, by inserting forward diodes into the primary side coil N1 in series, high-voltage noises from the secondary side coil output to the oscillation circuit MV are restrained. In addition, useless consumption currents flowing due to the noises while pulses are stopped are prevented, thereby achieving a low power consumption and a longer service life of the power source in a battery operation.

In order to generate the negative ions, it is necessary to apply a high voltage to an ion generating element such as an electrode and the like. In a conventional circuit being represented in FIG. 18, a winding transformer is employed, and by switching over between the transistors Q1 and Q2 by an output of the oscillation circuit MV having a direct current power source serve as an operation source, the electric current on the primary side of the pulse transformer PT is disconnected, and thereby a magnetic field is changed inside the pulse transformer PT. Then, on the secondary side of the pulse transformer PT, is generated an alternate current of high voltage that is proportional to the ratio of the winding numbers of the primary side coil N1 versus the secondary coil N2.

When a winding transformer is used, an output voltage being proportional to the ratio of the winding number of coils is obtained. For example, by increasing the ratio of the winding number to be as much as 1:100, a high voltage being necessary for ion generation can be obtained. However, when the secondary side of the transformer has a capacitive load, such as an ion generating element and the like, for example, then, on the secondary side of the transformer exists a resonance frequency being expressed as Formula 1 below; where a symbol “C” denotes a capacity of the load, a symbol “L” denotes an inductance viewed from the secondary side of the transformer, and a symbol “f” denotes a resonance frequency.

$$f = \frac{1}{2 \times π \sqrt{L \times C}} \qquad [ Formula 1 ]$$

And, when the resonance frequency on the secondary side of the pulse transformer differs from the frequency of the alternate current voltage being fed to the pulse transformer PT, which is, specifically, the output frequency of the oscillation circuit MV, the output voltage on the secondary side of the pulse transformer PT is decreased, whereby the efficiency of the circuit is reduced, which provides a problem.

The output frequency of the oscillation circuit MV and the resonance frequency on the secondary side of the pulse transformer PT deviates from the designed frequencies due to a variation of constant numbers of components during manufacturing, aging change in the constant number of components, environmental changes such as a change in the surrounding temperature and humidity, and a change in the capacity of the ion generating element that varies when a conductor comes close to a vicinity thereof A relationship between the deviation of the output frequency of the oscillation circuit MV from the resonance frequency on the secondary side of the pulse transformer PT, and the output voltage (the voltage which is applied to the ion generating element) will be described hereinafter.

A problem of a decrease in the output voltage becomes remarkable when the value of “L” is large and the value of “C” is small. Generally, it is known that the following Formula 2 and Formula 3 can be expressed; where a symbol “BW” denotes a bandwidth in which the output voltage lowers to “1/√2” of the maximum value, a symbol “C” denotes a capacity of a load, a symbol “L” denotes an inductance being viewed from the secondary side of the transformer, a symbol “R” denotes a resistance component of the load, a symbol “f” denotes the resonance frequency, and a symbol “Q” denotes a qualify factor of the resonance circuit.

$$\begin{matrix}BW = \frac{f}{Q} & [ Formula 2 ] \\ Q = \frac{1}{R} \times \sqrt{\frac{L}{C}} & [ Formula 3 ]\end{matrix}$$

The larger the value of “Q” is, the smaller the value of “BW” is. To be specific, when the value of “L” is large and the value of “C” is small, the bandwidth in which a high voltage is produced becomes narrow, so that the output voltage is decreased even when the output frequency of the oscillation circuit MV on the primary side deviates slightly from the resonance frequency on the secondary side of the transformer. Specifically, there is a problem that the efficiency is deteriorated.

Especially, when it is intended to produce a high voltage in a transformer, the above-mentioned value of “L” becomes large due to an increase in the winding number of a coil on the secondary side of the transformer, and as a result, a problem of a decrease in the output voltage due to a deviation of the frequency becomes remarkable. For example, when the output voltage is decreased to be 1/√2 times as much as the output voltage, the electric power is reduced for ½, so that the efficiency will be decreased for 50%.

FIG. 5 shows a diagram of a circuit modeling of the secondary side of a transformer. In FIG. 5, a symbol “Vac” denotes an alternate current signal source of 12V, a symbol “T” denotes a transformer, a symbol “Cz” denotes a load capacity, a symbol “Rs” denotes a resistance component of the load, and a symbol “TP” denotes a measuring point of the output voltage.

FIG. 3 shows a characteristic of a frequency versus an output voltage at a measuring point TP shown in FIG. 5. FIG. 3 shows an actual example having a characteristic of the output voltage, when the self inductance on the secondary side of the transformer shown in FIG. 5 is 230 mH, the load capacity is 10 pF, the resistance component of the load is 1280Ω. In addition, the horizontal axis indicates a frequency of an alternate current of the alternate current signal source Vac of 12V shown in FIG. 5, while the longitudinal axis indicates a voltage at the output voltage measuring point TP shown in FIG. 5.

According to this graph, the resonance frequency of the circuit shown in FIG. 5 is 95 kHz. When an alternate current signal of 12V and 95 kHz is fed to the primary side of the transformer, an output of approximately 4.7 kV is obtained at the output voltage measuring point TP. However, when the frequency deviates for 2 kHz, the voltage at the above-mentioned output voltage measuring point TP comes to be approximately 3.3 kV, which means that in a conversion into an electric power, the voltage is decreased for 50%. Therefore, there exists a problem that an amount of ion generation is reduced to be a half or less.

### SUMMARY OF THE INVENTION

In view of the conventionally experienced inconveniences being discussed above, it is an object of the present invention to provide a high voltage output device that can obtain an output voltage efficiently in spite of a fluctuation in the load capacity on the secondary side of a transformer, and provide an ion generator being provided therewith. In addition, it is another object of the present invention to provide an electronic apparatus and the like employing the aforementioned ion generator.

In order to achieve the above-mentioned objects, a high voltage output device in accordance with the present invention, which comprises a transformer that amplifies a voltage being fed to a primary side coil thereof so as to be produced from a secondary side coil thereof, and in which an alternate current input voltage is fed to the primary side coil, and an output voltage is taken out from the secondary side coil, further comprises a feedback circuit that feeds back the output voltage; and a voltage amplifying circuit that amplifies the fed-back voltage so as to be fed to the primary side coil. (First Configuration)

According to such a configuration as described hereinabove, since a voltage being produced from the secondary side of a transformer is fed back, a signal (a voltage) corresponding to a frequency of the voltage can be fed to the primary side of the transformer. Therefore, for example, when a resonance circuit is formed by having a capacitive load connected to the secondary side of the transformer, it is easy to practically offer a high voltage output device of high efficiency that can follow fluctuations in the resonance frequency (for example, due to a fluctuation in the capacitive load being connected to the secondary side of the transformer) if any. To be specific, by forming a resonance circuit system including the primary side and the secondary side of the transformer, it becomes easy to prevent a difference (deviation) between a voltage being fed from the primary side of the transformer and a resonance frequency on the secondary side of the transformer from occurring.

As a result, an alternate current signal of a resonance frequency component that is determined by an inductance and a load capacity on the secondary side of the transformer, specifically, an alternate current signal (an alternate current voltage) having a frequency at which a voltage being applied to the load is maximum, is fed back to an input of a voltage amplifying medium. In consequence, the oscillation circuit system oscillates at a frequency at which a voltage being applied to the load is maximum, so that a maximum output voltage can be attained by following fluctuations in a load capacity, if any, thereby achieving a high efficiency.

In addition, in accordance with the above-mentioned configuration, to be more concrete, when a resonance circuit is formed by having a capacitive load connected to the secondary side coil, the oscillation circuit may be configured in a manner that due to a closed circuit consisting of the transformer, the feedback circuit and the voltage amplifying circuit, a resonance frequency in the resonance circuit serves as an oscillation frequency. (Second Configuration)

According to the present configuration, since an oscillation circuit that oscillates at the resonance frequency on the secondary side of the transformer, such a high voltage output device can be offered practically as is very efficient and able to follow fluctuations in the resonance frequency. In addition, the oscillation frequency of the oscillation circuit is not always limited to be an oscillation frequency that is strictly in compliance with the resonance frequency in the resonance circuit, but a small error can be permitted within a range in which the object of the present invention can be achieved.

Moreover, in accordance with the above-mentioned configuration, the feedback circuit includes a voltage lowering circuit that lowers the output voltage and feeds back a voltage being lowered by the voltage lowering circuit; wherein, the voltage lowering circuit may lower the output voltage so as to be within a range of an allowable input voltage of the voltage amplifying circuit. (Third Configuration) In accordance with this third construction, it is possible to prevent such a failure as having the voltage amplifying circuit get damaged by a high voltage being fed back.

In addition, in accordance with the above-mentioned configuration, the voltage lowering circuit may comprise a first resistance element and a second resistance element, and may lower the output voltage by dividing a voltage between both terminals of the secondary side coil by employing the first resistance element and the second resistance element. (Fourth Configuration) By employing the resistance elements in such, a manner as described hereinabove, it is possible to relatively downsize a circuit for dividing a voltage between both terminals of the secondary side coil.

Moreover, in accordance with the above-mentioned configuration, the voltage lowering circuit may comprise a first capacitive element and a second capacitive element, and may lower the output voltage by dividing a voltage between both terminals of the secondary side coil by employing the first capacitive element and the second capacitive element. (Fifth Configuration) By employing the capacitive elements in such a manner as described hereinabove, it is possible to provide a circuit for dividing a voltage between both terminals of the secondary side coil with a relatively high resistance to pressure.

Furthermore, in accordance with the above-mentioned configuration, the voltage lowering circuit consists of substrate patterns that are formed on a substrate, and the substrate patterns are arranged so as to include a first capacitive portion and a second capacitive portion in which an electric capacitance is produced, with the substrate patterns serving as both electrodes. Then, the voltage lowering circuit may lower the output voltage by dividing a voltage between both terminals of the secondary coil by employing the first capacitive portion and the second capacitive portion. (Sixth Configuration)

In accordance with the present configuration, when a voltage lowering circuit consists of substrate patterns, it is possible to divide a voltage by employing a first capacitive portion and a second capacitive portion. Therefore, it is possible to lower the output voltage without having capacitive elements and the like installed separately. Substrate patterns herein correspond to, for example, strip lines, ground patterns, and the like that are installed to a substrate, but are not limited to.

Additionally, in accordance with the above-mentioned configuration, the first capacitive portion may be formed by a capacitive coupling of a first pattern and a second pattern that are any of the substrate patterns; and the first pattern and the second pattern may be arranged on a same surface of the substrate. (Seventh Configuration)

In accordance with the present configuration, for example, even when substrate patterns cannot be arranged on a back surface of a substrate, it is possible to form a first capacitive portion.

Moreover, in accordance with the above-mentioned configuration, the first capacitive portion is formed by a capacitive coupling of a first pattern and a second pattern that are any of the substrate patterns, and the first pattern and the second pattern may be arranged, respectively, on surfaces being opposite to each other in the substrate. (Eighth Configuration)

In accordance with the present configuration, by putting it into practice to have substrate patterns actually installed to both surfaces of a substrate, a substrate area can be reduced easily, and a substrate can be miniaturized easily. In addition, by controlling a characteristic (a specific inductive capacity) of a substrate material and a thickness of a substrate, it is possible to adjust a capacity of the first capacitive portion.

Moreover, in accordance with the above-mentioned configuration, the first pattern may be connected to a secondary side coil of the transformer, and the second pattern may be connected to the voltage amplifying circuit. (Ninth Configuration) In accordance with this configuration, an output voltage being produced from the secondary coil of the transformer can be lowered by voltage division, and fed back to the voltage amplifying circuit easily.

Additionally, in accordance with the above-mentioned configuration, the first pattern or the second pattern may be formed with a part thereof cut off, and a capacity of the first capacitive portion may change by connecting the cut-off parts each other. (Tenth Configuration)

In accordance with the present configuration, by connecting the cut-off parts by soldering, for example, it is possible to change the capacity of the first capacitive portion. As a result, for example, even when an output voltage has a variation due to a variation in a specification of components configuring a voltage output device, it is easy to mitigate the variation by changing the capacity of the first capacitive portion (by adjusting).

In addition, in accordance with the above-mentioned configuration, the second capacitive portion may be formed by a capacitive coupling of any of the substrate patterns to a ground pattern in the substrate. (Eleventh Configuration) In accordance with this configuration, by employing a ground pattern in the substrate so as to serve as one of the electrodes in the second capacitive portion, it is possible to reduce a number of the substrate patterns to be arranged as much as possible.

Moreover, in accordance with the above-mentioned configuration, the oscillation circuit may be a self-excited oscillation circuit that actuates, with a noise voltage, which is generated by a start of power supply to the voltage amplifying circuit, serving as a starting point, and may be provided with a noise voltage amplifying medium that amplifies the noise voltage. (Twelfth Configuration)

Generally, it is known that when an electric power starts to be supplied to a voltage amplifying circuit such as an operating amplifier and the like, a noise voltage (a voltage being produced in a transient manner) is generated temporarily due to an effect of a change at that time. Therefore, in accordance with the present construction, it is possible to have an oscillation circuit (that must be a self-excited oscillation circuit) start oscillation, with a noise voltage serving as a starting point. As a result, it is unnecessary to provide a process for starting oscillation separately from the power supply, whereby the configuration of a high voltage output device can be simplified. In addition, because a a noise voltage amplifying medium is provided, it is possible to prevent, as much as possible, such a problem from occurring as the oscillation does not start because the noise voltage is minimal.

Moreover, a high voltage output device in accordance with the present invention, which comprise a transformer that amplifies a voltage being fed to a primary side coil thereof so as to be produced from a secondary side coil thereof, and in which an alternate current input voltage is fed to the primary side coil and an output voltage is produced from the secondary side coil, further comprises a feedback coil that feeds back the output voltage; and an alternate current signal producing medium that produces an alternate current signal having a frequency corresponding to the fed-back voltage so as to be fed to the primary side coil. (Thirteenth Configuration)

In accordance with the above-mentioned configuration, a voltage being produced from the secondary side of the transformer is fed back, so that an alternate current signal (voltage) having a frequency corresponding to the voltage can be fed to the primary side of the transformer. Therefore, for example, when a resonance circuit is formed by having a capacitive load connected to the secondary side of the transformer, it is easy to practically offer a high voltage output device of high efficiency that can follow fluctuations of a resonance frequency (that can supply the primary side coil with an alternate current signal having a same frequency as the resonance frequency), if any (for example, fluctuations due to a change in the capacitive load that is connected to the secondary side of the transformer).

Additionally, in accordance with the above-mentioned configuration, when a resonance circuit is formed by having a capacitive load connected to the secondary side coil, the alternate current signal producing medium may detect a resonance frequency of the resonance circuit, based on the fed-back voltage, and may produce an alternate current voltage, which has a same frequency as the resonance frequency being detected, so as to serve as the alternate current signal. (Fourteenth Configuration)

In accordance with the present configuration, since an alternate current voltage having the same frequency as the resonance frequency in the resonance circuit is fed to the primary side of the transformer, it is possible to practically offer a high voltage output device of high efficiency.

Moreover, in accordance with the above-mentioned configuration, the alternate current signal generating portion may comprise a first pulse producing portion that produces a single pulse signal; a waveform shaping portion that digitalizes the voltage being fed back; a frequency measuring portion that measures a frequency of the voltage being digitalized; a frequency memory portion that memorizes the frequency being measured; a second pulse producing portion that produces a pulse signal having a same frequency as the frequency being memorized; a switch that has one of the first pulse producing portion and the second pulse producing portion connected to the primary side coil so as to be switched over, wherein the alternate current signal may be the pulse signal. (Fifteenth Configuration)

In accordance with the present configuration, the resonance frequency in the resonance circuit can be easily detected, and at the same time, an alternate current signal having the same frequency as the resonance frequency can be produced easily so as to be fed to the primary side coil.

Additionally, in accordance with the above-mentioned configuration, the feedback circuit may include a rectifying element, and may feed back the output voltage to the alternate current signal producing medium after having the output voltage rectified by the rectifying element. (Sixteenth Configuration)

Moreover, in accordance with the above-mentioned configuration, the feedback circuit may include a bias addition circuit that adds a predetermined bias voltage to the voltage to be fed back. (Seventeenth Configuration)

In accordance with the above-mentioned configuration, it is easy to make a voltage, which is digitalized by the waveform shaping portion (a feedback voltage), be a positive value only, while maintaining information on the frequency. Therefore, the waveform shaping portion can be made up by employing a simple element such as an analog-digital converter and the like.

In addition, in accordance with the above-mentioned configuration, the bias voltage may be produced by having a voltage being supplied from the power source line divided by a plurality of resistance elements. (Eighteenth Configuration)

Moreover, in accordance with the above-mentioned configuration, the feedback circuit may include a voltage lowering circuit that lowers the output voltage, and may feed back a voltage being lowered by the voltage lowering circuit. (Nineteenth Configuration) In accordance with this configuration, it is possible to prevent such a problem from occurring as the alternate current signal producing medium gets damaged by a high voltage being fed back.

In accordance with the above-mentioned configuration, the voltage lowering circuit may comprise a first resistance element and a second resistance element, and may lower the output voltage by dividing a voltage between both terminals of the secondary side coil by using the first resistance element and the second resistance element. (Twentieth Configuration) By having the resistance elements used as described above, it is possible to relatively miniaturize a circuit for dividing a voltage between both terminals of the secondary side coil.

Moreover, in accordance with the above-mentioned configuration, the voltage lowering circuit may comprise a first capacitive element and a second capacitive element, and may lower the output voltage by dividing a voltage between both terminals of the secondary side coil by using the first capacitive element and the second capacitive element. (Twenty-First Configuration) By having the capacitive elements used as described hereinabove, it is possible to make a circuit for dividing a voltage between both terminals of the secondary side coil have a relatively high resistance to pressure.

Furthermore, in accordance with the above-mentioned configuration, the voltage lowering circuit may consist of substrate patterns that are formed on a substrate, having the substrate patterns arranged so as to include a first capacitive portion and a second capacitive portion that are portions in which an electric capacitance is produced with the substrate patterns serving as both electrodes, and may lower the output voltage by dividing a voltage between both terminals of the secondary side coil by using the first capacitive portion and the second capacitive portion. (Twenty-Second Configuration)

In accordance with the present configuration, when the voltage lowering circuit consists of substrate patterns, it is possible to divide a voltage by employing a first capacitive portion and a second capacitive portion. Therefore, the output voltage can be lowered without having capacitive elements and the like installed separately. In addition, substrate patterns herein correspond to, for example, strip lines, ground patterns, and the like that are installed to a substrate, but are not limited to.

In addition, in accordance with the above-mentioned configuration, the first capacitive portion may be formed by a capacitive coupling of a first pattern and a second pattern that are any of the substrate patterns, and the first pattern and the second pattern may be arranged on a same surface of the substrate. (Twenty-Third Configuration)

In accordance with the present configuration, for example, even when substrate patterns cannot be arranged on a back surface of a substrate, it is possible to form a first capacitive portion.

In addition, in accordance with the above-mentioned configuration, the first capacitive portion is formed by a capacitive coupling of a first pattern and a second pattern that are any of the substrate patterns, and the first pattern and the second pattern may be arranged, respectively, on surfaces being opposite to each other in the substrate. (Twenty-Fourth Configuration)

In accordance with the present configuration, by putting it into practice to have substrate patterns actually installed to both surfaces, a substrate area can be reduced easily, and a substrate can be miniaturized easily. Additionally, by controlling a characteristic (a specific inductive capacity) of a substrate material and a thickness of a substrate, it is possible to adjust a capacity of the first capacitive portion.

Moreover, in accordance with the above-mentioned configuration, the first pattern may be connected to a secondary side coil of the transformer, and the second pattern may be connected to the alternate current signal producing medium. (Twenty-Fifth Configuration) In accordance with this configuration, an output voltage being produced from the secondary coil of the transformer can be lowered by voltage division, and fed back to the alternate current signal producing medium easily.

Furthermore, in accordance with the above-mentioned configuration, the first pattern and the second pattern may be formed with a part thereof cut off, and a capacity of the first capacitive portion may change by connecting the cut-off parts each other. (Twenty-Sixth Configuration)

In accordance with the present configuration, by connecting the cut-off parts by soldering, for example, it is possible to change the capacity of the first capacitive portion. As a result, for example, even when an outage voltage has a variation due to a variation in a specification of components configuring a voltage output device, it is easy to mitigate the variation by changing the capacity of the first capacitive portion (by adjusting).

In addition, in accordance with the above-mentioned configuration, the second capacitive portion may be formed by a capacitive coupling of any of the substrate patterns to a ground pattern in the substrate. (Twenty-seventh Configuration) In accordance with this configuration, by employing a ground pattern in the substrate so as to serve as one of the electrodes in the second capacitive portion, it is possible to reduce a number of the substrate patterns to be arranged as much as possible.

Moreover, an ion generator may be provided with an ion generating element that generates ions and/or ozone from the air, by employing a high voltage output device in accordance with the above-mentioned configuration, and output voltages of the high voltage output device. (Twenty-Eighth Configuration)

In accordance with the present configuration, in order to generate the ions and/or ozone from the air, it is possible to use the output voltages that are efficiently produced by a high voltage output device in accordance with any of the above-mentioned first through twenty-seventh configurations. As a result, it is possible to generate the ions and/or ozone relatively easily.

In addition, an ion generator may comprise a high voltage output device in accordance with the above-mentioned configuration; ion generating elements that generate the ions and/or ozone from the air by using an output voltage of the high voltage output device; a switching-over portion that switches over a ratio of voltage amplification in the voltage amplifying circuit; and a control medium that controls a state of generation of the ions and/or ozone in the ion generating elements by switching over the output voltage by way of changing over the ratio of the voltage amplification. (Twenty-Ninth Configuration)

Moreover, an ion generator may comprise a high voltage output device in accordance with the above-mentioned configuration; ion generating elements that generate the ions and/or ozone from the air by using an output voltage of the high voltage output device; a switching-over portion that changes over a level of the alternate current signal; and a control medium that controls a state of generation of the ions and/or ozone in the ion generating elements by switching over the output voltages by way of changing over the level of the alternate current signal. (Thirtieth Configuration)

In accordance with the above-mentioned configurations, by having the ratio of voltage amplification in a voltage amplifying circuit or the level of an alternate current signal changed over, the output voltages of the high voltage output device are changed over, and the amount of generation of the ions and the ozone depends on the voltage between both electrodes that are arranged by way of the air. As a result, it is possible to easily control the amount of generation of the ions and/or ozone, and to practically offer an ion generator having a high versatility, by putting such control into practice in accordance with the situation of each time.

Furthermore, in accordance with the above-mentioned configurations, in addition to generation of the ions and the ozone, an ion generator may be provided with a control state setting medium for setting of the control state in the control medium by selecting from at least four operation modes, wherein the four operation modes include a first operation mode that generates the ions without generating the ozone; a second operation mode that generates less than a predetermined amount of the ozone; a third operation mode that generates more than the predetermined amount of the ozone; and a fourth operation mode that generates neither the ions nor the ozone. (Thirty-First Configuration)

In accordance with the present configuration, since the control state can be set by selecting from at least four operation modes with the control state setting medium, it is possible to generate the ions and/or ozone corresponding to the situation of each time more easily.

In addition, an electronic apparatus, which is provided with an ion generator in accordance with the above-mentioned configuration, may be equipped with an ion guiding medium to guide the ions and/or ozone being generated by the ion generator so as to come to contact with the electronic apparatus partially or entirely. (Thirty-Second Configuration)

In accordance with the present configuration, it is possible to generate the ions and/or ozone having a dust-removal action or sterilizing and bacteria-elimination actions, and induce them so as to come to contact with an electronic apparatus partially or entirely. As a result, the bacteria can be killed and eliminated in the electronic apparatus, whereby the electronic apparatus can be maintained in a hygienic condition.

Moreover, in accordance with the above-mentioned configuration, an electronic apparatus may comprise contact type information input portions for a person to input information by direct contact, and the ion guiding medium may guide the ions and/or ozone to the contact type information input portions. (Thirty-Third Configuration)

In accordance with the present configuration, an electronic apparatus can have a person input information by direct contact by way of contact type information input portions, and can guide the ions and/or ozone to the contact type information input portions, so as to remove dusts or kill and eliminate the bacteria. Therefore, in addition to being high convenient, the electronic apparatus can be superior from a hygiene viewpoint.

In addition, in accordance with the above-mentioned configuration, to be more concrete, the contact type information input portions may include at least either of a device into which a biometric information is fed; and a key for key operation. (Thirty-Fourth Configuration)

Moreover, in accordance with the above-mentioned configuration, an enclosure including the contact type information input portions may be provided, and the enclosure may have a space being adjacent to the contact type information input portions sealed and opened freely. And then, the ion guiding medium may guide the ions and/or ozone to the space. (Thirty-Fifth Configuration)

In accordance with the present configuration, when the space being adjacent to the contact type information input portions is sealed, it is possible to perform sterilization and the like efficiently by guiding the ions and/or ozone to the space; and when the space is opened, a user can input information easily by way of the contact type information input portions.

Moreover, in accordance with the above-mentioned information, an electronic apparatus comprises a first enclosure that includes a first external surface; a second enclosure that includes a second external surface; and a hinge portion that connects the first enclosure and the second enclosure so as to be rotatable; and is a foldable type of electronic apparatus that can be folded by the rotating operation, with the first external surface and the second external surface approximately facing each other; wherein, the contact type information input portions are installed to a portion on the first external surface or on the second external surface, which is held by both of the enclosures, when the electronic apparatus is in the folded condition; and the ions guiding medium may guide the ions and/or ozone to a space that is held by the two enclosures in the folded condition. (Thirty-Sixth Configuration)

In accordance with the present configuration, since an electronic apparatus is foldable, having the contact type information input portions held by both enclosures in the folded condition, it is very convenient, for example, serving as a cellular phone. Furthermore, since the ions and/or ozone is guided to the space being held by the two enclosures in the folded condition (that has a better sealing property than a space that is completely opened, because it is separated at least by the two enclosures), dust removal as well as sterilization and bacteria elimination can be performed efficiently in the contact type information input portions.

In addition, in accordance with the above-mentioned configuration, the electronic apparatus may have an approximately sealed space formed in a portion that is held by the two enclosures when it is in the folded condition; wherein, the contact type information input portions may be installed to a position being adjacent to the approximately sealed space, and the ion guiding medium may guide the ions and/ozone to the approximately sealed space. (Thirty-Seventh Configuration)

In accordance with the present configuration, with the electronic apparatus in the folded condition, the contact type information input portions are in contact with the approximately sealed space, and the ions and/or ozone are guided to the space. Therefore, dust removal as well as sterilization and bacteria elimination can be performed more efficiently in the contact type information input portions.

An “approximately sealed space” herein is not limited to a space that is completely sealed, but may be such a space as can be filled with the ions or the ozone although a small leaking hole exists therein.

To be more concrete, for example, the first external surface or the second external surface may be provided with a protruding portion of rubber material, and the approximately sealed space may have the first external surface and the second external surface serve as the bottom surfaces thereof, and have the protruding portion and/or the hinge portion serve as side surfaces thereof. (Thirty-Eighth Configuration)

By having a protruding portion of rubber material installed thereto, it is possible to enhance the sealing degree in the approximately sealed space, and at the same time, it is possible to utilize the protruding portion as a buffer material that prevents the two enclosures from being damaged due to contact when the electronic apparatus is folded.

Additionally, in accordance with the above-mentioned configuration, the ion guiding medium may be provided with an ion ejection outlet that ejects the ions and/or ozone; and the contact type input portions may be installed to a position being opposite to the ion ejection outlet on the second external surface when the electronic apparatus is in the folded condition as described above. (Thirty-Ninth Configuration)

In accordance with the present configuration, the ions and/or ozone may be easily guided in a direction of ejection by way of the ion ejection outlet. Moreover, the contact type information portions are installed to a position that is opposite to the ion ejection outlet, with the electronic apparatus in the folded condition. Therefore, by utilizing a force of ejection, the ions and/or ozone can come to contact with the contact type information input portions efficiently, whereby dust removal as well as sterilization and bacteria elimination can be performed more efficiently in the contact type information input portions.

Moreover, a container may be provided with an ion generator in accordance with the above-mentioned configuration, and may have an inside thereof house an object in approximately sealed condition, wherein, the ions and/or ozone being generated by the ion generator may be discharged to the inside thereof. (Fortieth Configuration)

A container in accordance with the present configuration may have the ions and/or ozone efficiently come to contact with an object being housed therein, and thereby, dust removal as well as sterilization and bacteria elimination can be performed efficiently in the object.

In addition, when an electronic apparatus is a thermometer unit that comprises a thermometer, and a container in accordance with the above-mentioned configuration for housing the thermometer inside thereof (Forty-First Configuration), it is easy to maintain the thermometer, which is one of clinical instruments, in a hygienic condition.

A high voltage output device in accordance with the present invention comprises a transformer that amplifies a voltage being fed to a primary side coil so as to be produced from a secondary coil; a load connecting portion that has a capacitive load connected to the secondary side coil so as to form an LC resonance circuit; a voltage output portion that produces an alternate current voltage to the primary side coil; a feedback coil that feeds back a voltage being generated by the LC resonance circuit to the voltage output portion; wherein, the voltage output portion detects a resonance frequency of the resonance circuit, based on the fed-back voltage, and feeds an alternate current voltage of the resonance frequency to the primary side coil. (Forty-Second Configuration)

### DESCRIPTION OF THE DRAWING

These and other objects and features of the present invention will be apparent from the following detailed description of preferred embodiments thereof taken in conjunction with the accompanying drawings.

FIG.1 is a block diagram showing an overview of an ion generator in accordance with a first embodiment of the present invention.

FIG. 2 is a diagram illustrating an example of configuration shown in FIG. 1. (Resistance elements are applied to a voltage dividing circuit.)

FIG. 3 is a graph showing a characteristic of a frequency versus an output voltage at a measuring point PT shown in FIG. 5.

FIG. 4 is a graph showing an amount of generation of ions and ozone.

FIG. 5 is a circuit diagram modeling a secondary side of a transformer.

FIG. 6A is a diagram illustrating the example of configuration shown in FIG. 1. (Capacitive elements are applied to a dividing circuit.)

FIG. 6B is a diagram illustrating an example of configuration shown in FIG. 6A, having substrate patterns arranged so as to omit the capacitive elements.

FIG. 6C is a diagram illustrating a structure in a vicinity of a capacitive coupling portion shown in FIG. 6B.

FIG. 6D is a diagram illustrating the example of configuration shown in FIG. 6A, having the substrate patterns arranged so as to omit the capacitive elements.

FIG. 6E is a diagram illustrating the example of configuration shown in FIG. 6A, having the substrate patterns arranged so as to omit the capacitive elements.

FIG. 6F is a diagram illustrating the example of configuration shown in FIG. 6A, having the substrate patterns arranged so as to omit the capacitive elements.

FIG. 7 is a block diagram showing an overview of an ion generator in accordance with a second embodiment of the present invention.

FIG. 8 is a diagram illustrating an example of configuration shown in FIG. 12. (Rectifying elements are provided to a feedback circuit.)

FIG. 9A, FIG. 9B, FIG. 9C, and FIG. 9D are diagrams illustrating ion generation shown in FIG. 13.

FIG. 10 is a diagram illustrating the example of configuration shown in FIG. 12. (A bias voltage is added to a feedback voltage.)

FIG. 11A, FIG. 113B, and FIG. 11C are diagrams illustrating an ion generator shown in FIG. 15.

FIG. 12 is a block diagram of an ion generator in accordance with a third embodiment of the present invention.

FIG. 13A and FIG. 13B show perspective views of a cellular phone unit in accordance with a fourth embodiment of the present invention, including a front surface and a back surface thereof in a perspective manner, with the cellular phone unit opened:

FIG. 14A and FIG. 14B show perspective views of a cellular phone unit in accordance with the fourth embodiment of the present invention, including a side view and a top view thereof, with the cellular phone unit closed.

FIG. 15 is a functional block chart of a cellular phone unit shown in FIG. 13 and FIG. 14.

FIG. 16 is a perspective view of a thermometer unit (with a lid thereof opened) in accordance with a fifth embodiment of the present invention.

FIG. 17 is a perspective view of a thermometer unit (with a lid thereof closed) in accordance with the fifth embodiment of the present invention

FIG. 18 is a circuit diagram showing a high voltage generating circuit in a conventional negative ion generator.

### DESCRIPTION OF THE PREFERRED EMBODIMENTS

Embodiments of the present invention will be described hereinafter for each of a first through a fifth embodiments separately.

### First Embodiment

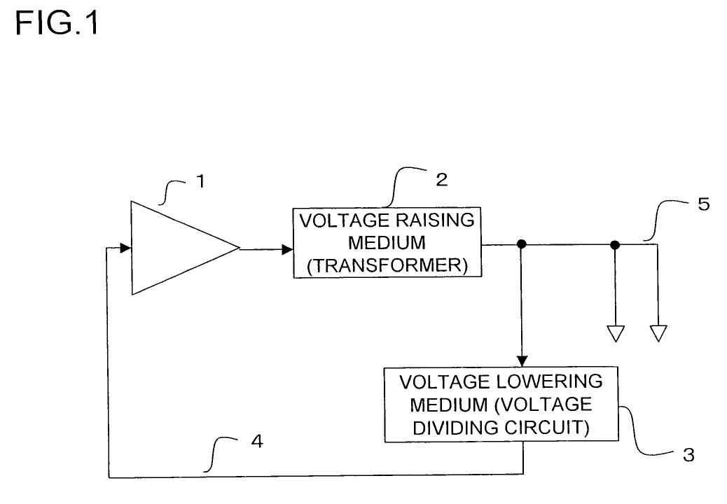

By referring to the drawings, a first embodiment of an ion generator in accordance with the present invention will be described hereinafter. FIG. 1 is a block diagram showing an overview of an ion generator in accordance with the present embodiment of the present invention.

An ion generator shown in FIG. 1 comprises an alternate signal amplifying medium 1; a winding transformer (a voltage raising medium) 2; a voltage lowering medium (a voltage dividing circuit) 3; a feedback circuit 4; and ion generating elements 5, and the like. An ion generator that has ion generating elements 5 excluded can be regarded as a high voltage output device that feeds a high voltage to a secondary side of the winding transformer 2. “A high voltage” herein means a voltage that is as high as a voltage at which ions are generated from the ion generating elements 5 when a voltage is applied to the ion generating elements 5, and a level of such a voltage (in an absolute value) is, for example, more than several hundred volts.

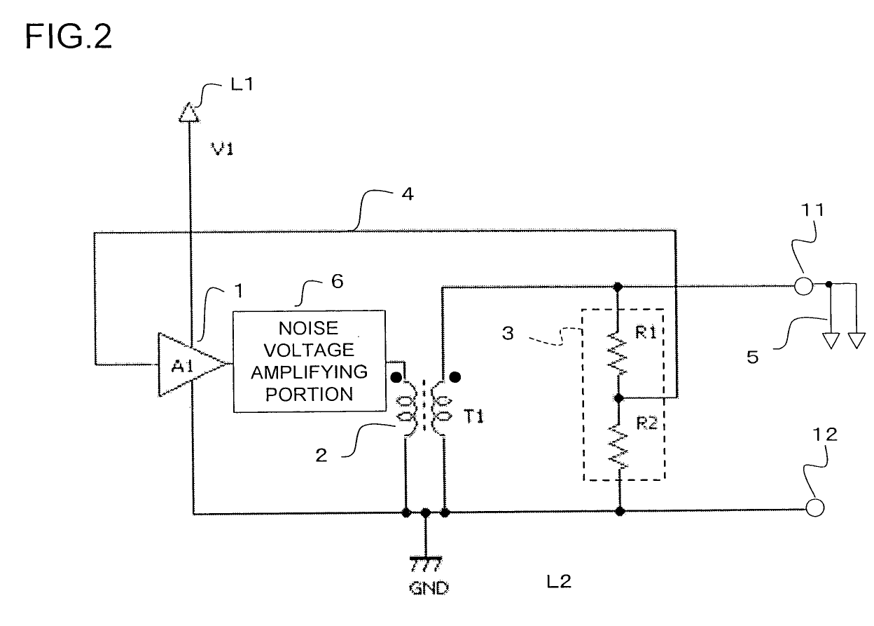

FIG. 2 shows an example of a concrete example of configuration of a circuit of an ion generator shown in FIG. 1. As shown in this figure, the alternate current signal amplifying medium 1 in accordance with the present embodiment is, for example, a voltage amplifier such as an operating amplifier, an MOSFET, and the like. When an alternate current voltage is fed to an input terminal of the alternate current signal amplifying medium 1, an alternate current voltage, which has an approximately same phase as the alternate current signal being fed, and has a voltage level (an amplitude) thereof amplified, will be produced from an output terminal.

In addition, the winding transformer (referred as a “transformer” hereinafter) 2 has a secondary side coil thereof have a sufficient larger winding number than a primary side coil thereof As a result, when an alternate current voltage is fed to the primary side coil, an alternate current voltage, which has a same phase as the alternate current voltage being fed, and has the voltage level (the amplitude) thereof amplified, is produced from the secondary side coil. Moreover, a stage before the primary side coil is provided with a noise voltage amplifying portion 6 that amplifies a voltage (a noise voltage) being produced in a transient manner in accordance with initiation of a power supply to the alternate current signal amplifying medium 1.

The voltage lowering medium 3 has a first resistance element R1 (referring a resistance value thereof as “r1”) and a second resistance element R2 (referring a resistance value thereof as “r2”), which are connected in series, mounted between two terminals of the secondary side coil of the transformer 2 so as to be connected. To be specific, by dividing a voltage between the two terminals by the first resistance element R1 and the second resistance element R2, the voltage is lowered. As a result, an alternate current voltage, which has the same phase as an alternate current voltage being fed by the secondary side coil of the transformer 2 and is divided, is produced from between the first resistance element R1 and the second resistance element R2, so as to be fed to the alternate current signal amplifying medium 1 by way of the feedback circuit 4.

In addition, a symbol “L1” shown in FIG. 2 denotes a power source line that supplies an electric power to the alternate current signal amplifying medium 1, while a symbol “L2” denotes a ground line (a reference potential line) of zero volt. A number “11” denotes a first terminal that is connected to an output on the secondary side of the transformer 2, being a terminal that connects one side of electrodes of the ion generating elements. A number “12” denotes a second terminal that is connected to the ground line (the reference potential line) of zero volt, being a terminal that connects the other side of the electrodes of the ion generating elements.

Moreover, the ion generating elements 5 include two electrodes that are connected to the first terminal 11 and the second terminal 12, respectively. A space between these two electrodes is opened, so that the air can come in and out freely. As a result, the space can be put into a state of discharge by generating a high voltage between the electrodes, and thereby the ions or ozone can be generated from the air. Additionally, from a viewpoint of an electric circuit, these electrodes can be treated in a same manner as capacitors (capacitive loads).

An “ion” herein concretely represents “O₂⁻” that is produced from oxygen in the air, “H⁺” that is produced from the water vapor, and the like. It is known that these elements are produced when a voltage of more than a predetermined amount is applied in the air. In addition, as described hereinafter, it is known that the ions have such actions as making it easy to remove dusts being attached to an abject (an action of dust removal), and sterilizing and bacteria eliminating actions, and it is also known that some ions have such an effect as act on a human body so as to calm a person and make the person feel easy.

Next, operations of the ion generator will be described hereinafter. First, when the power source line L1 starts supplying the electric power, temporary fluctuations of a voltage occur at an output terminal of the alternate current signal amplifying medium 1 due to an effect of a change in a state of the electric power (due to generation of a noise). A distribution of frequencies of the voltage fluctuations immediately after the supply of the electric power exits in a wide band.

An alternate current signal (a noise voltage) having this wide frequency distribution is first fed to the noise voltage amplifying portion 6. Then, the noise voltage is amplified so as be large enough to initiate oscillation by the noise voltage amplifying portion 6. After that, the noise voltage is fed to the primary side coil of the transformer 2, having the voltage amplified, so as to be produced from the secondary side coil. Amplification treatment in the noise voltage amplifying portion 6 is executed only before the oscillation starts, and is not executed after the oscillation starts.

In this condition, the property of the secondary coil of the transformer 2 is approximately equivalent to a coil. In addition, the properties of the ion generating elements 5 are approximately equivalent to a capacitor. Therefore, on the secondary side of the transformer 2, is formed a resonance circuit by the secondary side coil of the transformer 2 and the capacitor of the ion generating elements 5. As a result, only alternate current signals that have an approximately same frequency as a resonance frequency of the resonance circuit show up (and are amplified), and alternate current signals that have other frequencies than the above-mentioned frequency are damped.

On the other hand, the voltage lowering medium 3 lowers an alternate current voltage (an alternate current signal) that is produced by the resonance circuit as described hereinabove, and feeds it back to the input side of the alternate current signal amplifying medium 1. The resistances (r1 and r2) of the first resistance element R1 and the second resistance element R2 in the voltage lowering medium 3 are set in a manner that a level of the voltage to be fed back is set to be within a range of a permissible input voltage (for example, a rated voltage and the like) of the alternate current signal amplifying medium 1.

In consequence, the alternate current signal amplifying medium 1 is prevented from being damaged due to an excessive voltage load. In addition, by employing resistance elements as a dividing circuit in such a manner as has been described, it is possible to relatively downsize the voltage dividing circuit (to be smaller, being compared with a case of employing a capacitor, for example).

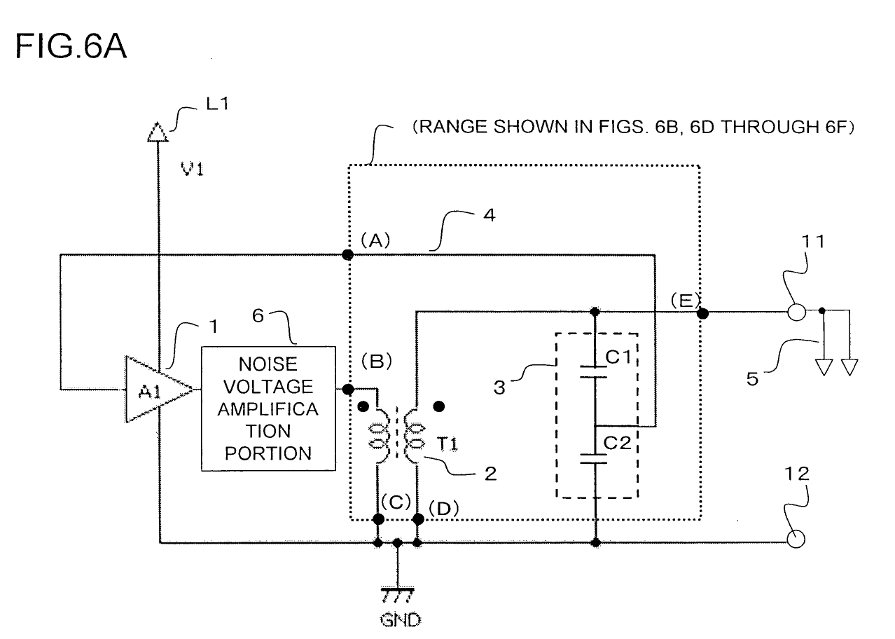

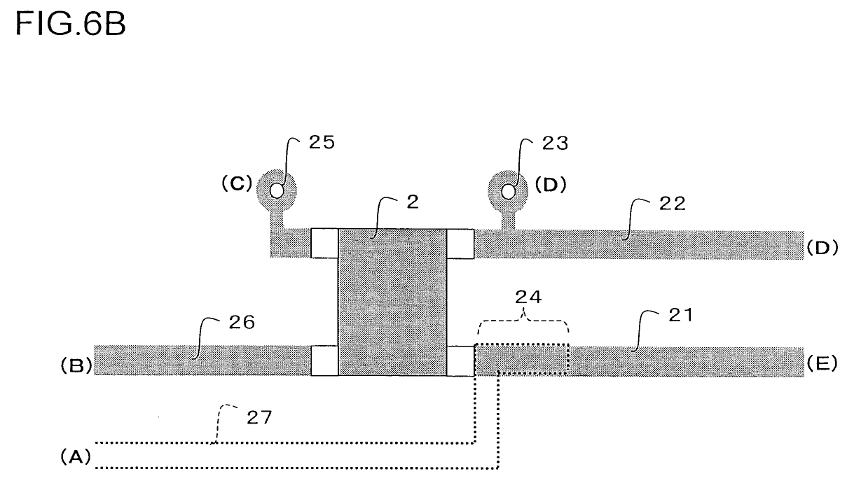

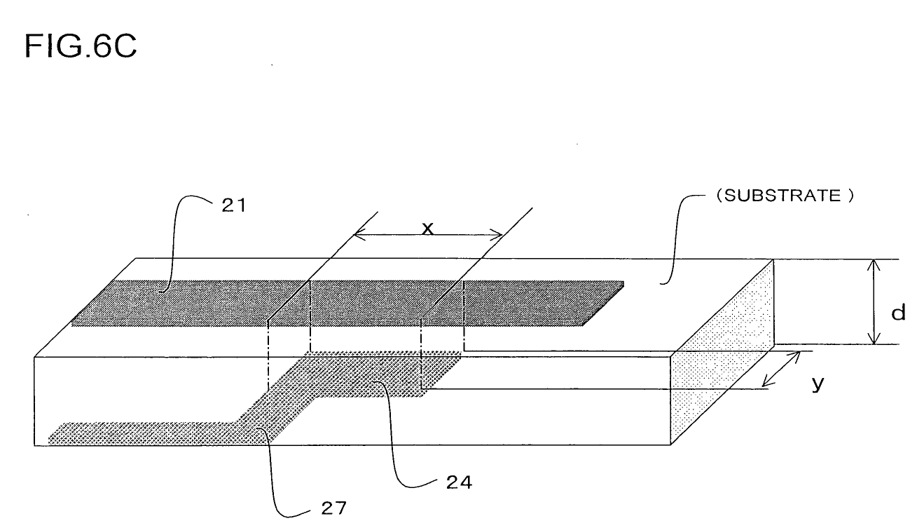

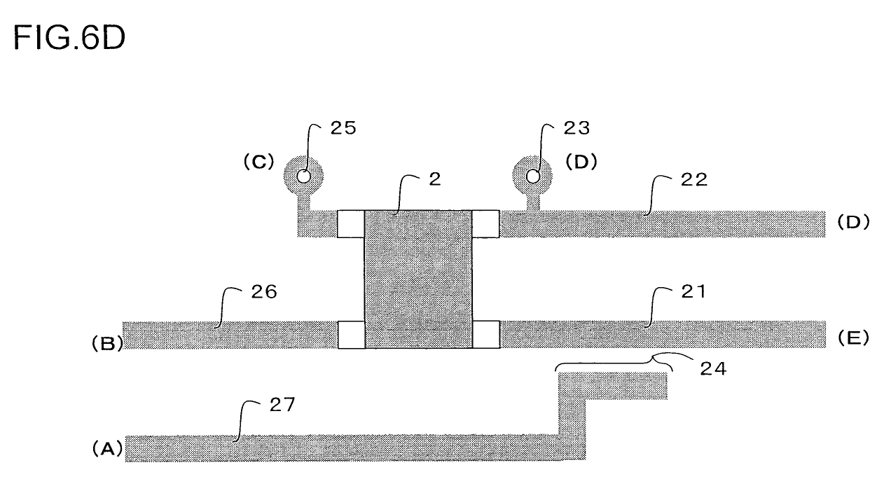

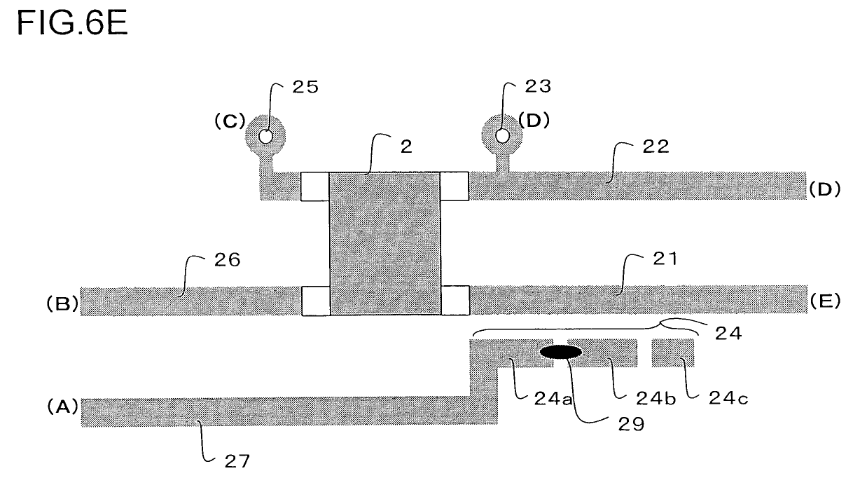

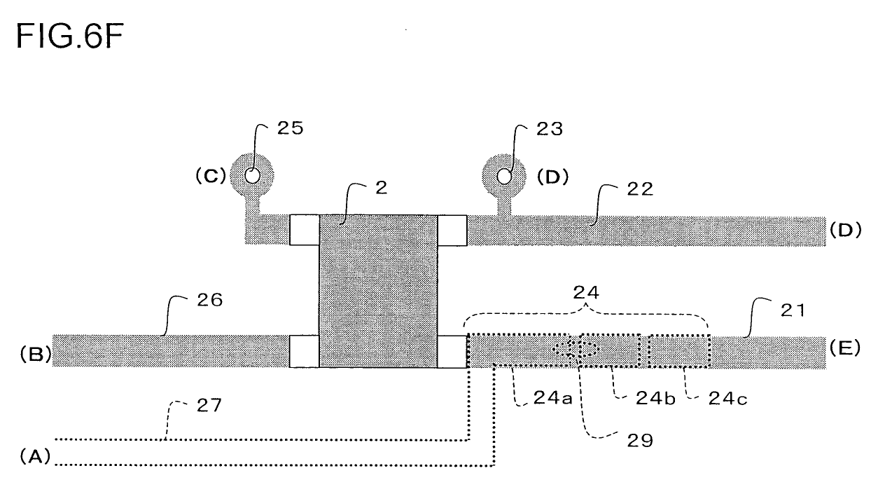

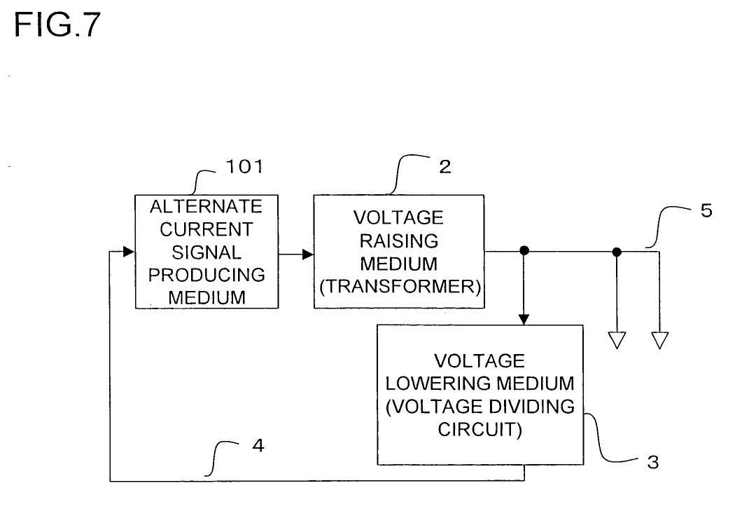

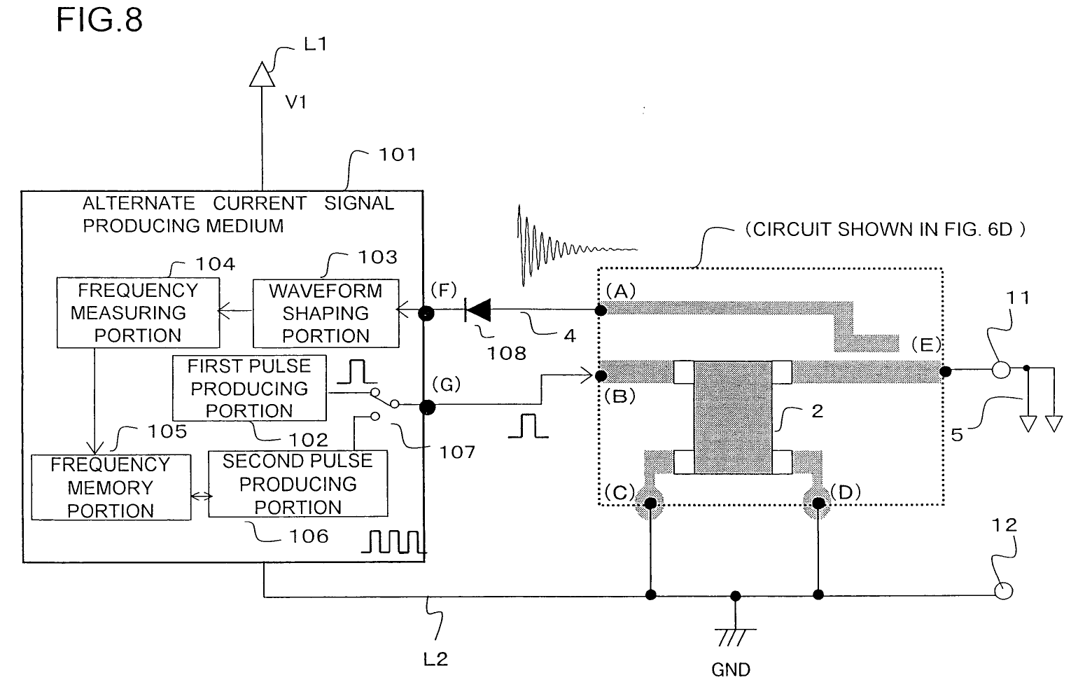

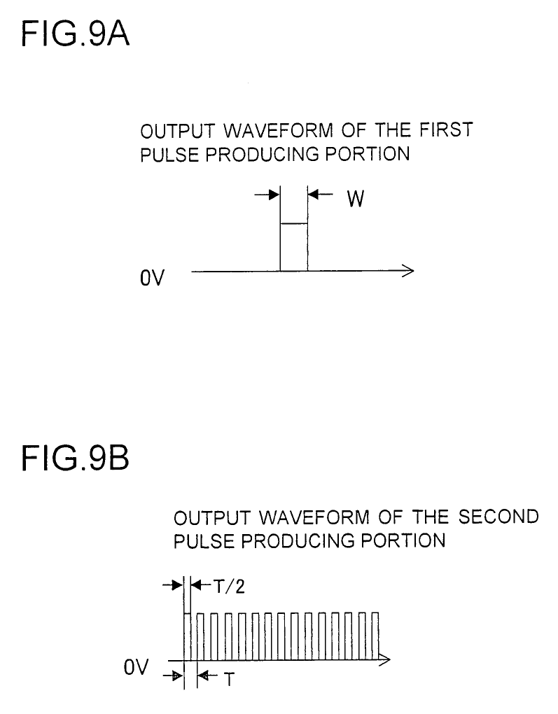

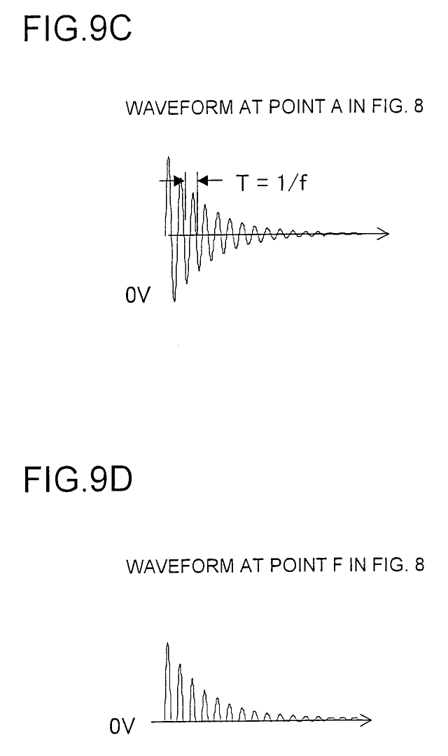

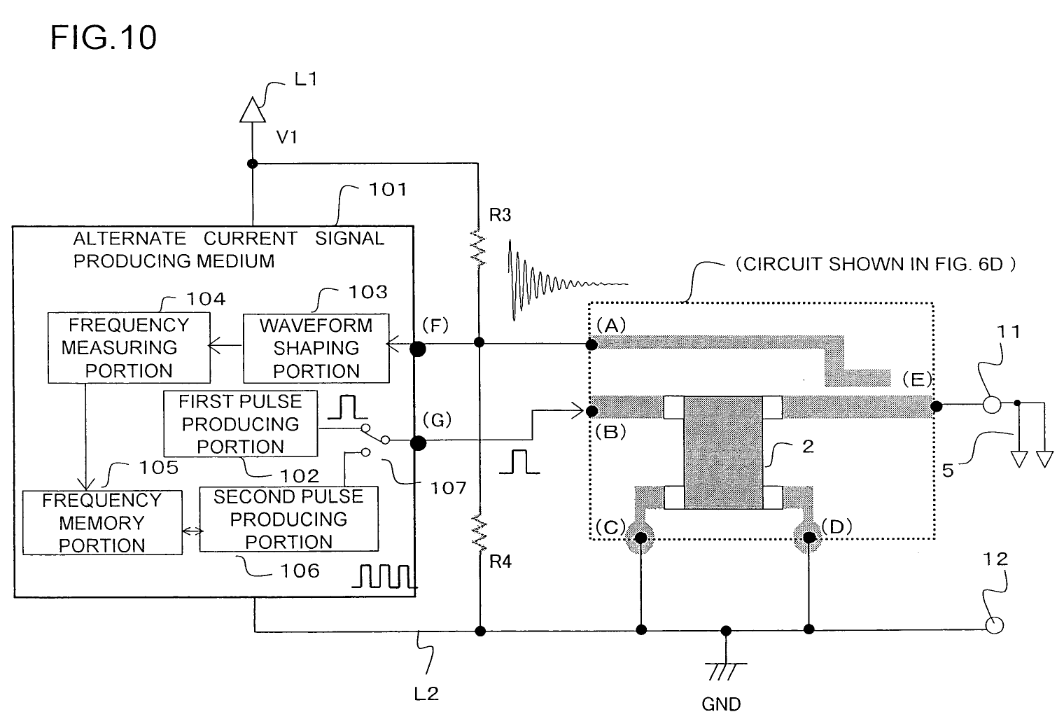

As shown in FIG. 6A, instead of the above-mentioned resistance elements in the voltage dividing circuit, capacitive elements (capacitors) may be employed, and thereby, the voltage dividing circuit can have a higher resistance against pressure.

Furthermore, when the voltage dividing circuit is constructed on a substrate, the above-mentioned capacitive elements may be omitted in actual installation, by adopting an arrangement (a combination) of such substrate patterns (a strip line, a ground pattern, and the like) as generate electric capacities. A concrete example of configuration of the voltage dividing circuit in the above-mentioned case is shown in FIG. 6B. The configuration of the substrate shown in FIG. 6B corresponds to a region that is surrounded by a dotted line in FIG. 6A, having a feedback pattern provided on a back surface of the substrate. In addition, symbols (A) through (E) in FIG. 6B correspond to the symbols (A) through (E) in FIG. 6A.

In accordance with the present configuration, the substrate includes substrate patterns 21, 22, 26 and 27; through-holes 23 and 25, and a transformer 2. The pattern 21 extends so as to connect one terminal on the secondary side of the transformer 2 to the first terminal 11. In addition, the pattern 22 extends so as to connect the other terminal on the secondary side of the transformer 2 to the second terminal 12.

The through-hole 23 has the pattern 22 connected to the ground line (a ground pattern), and the through-hole 25 has one terminal on the primary side of the transformer 2 connected to the ground line. The pattern 26 extends so as to have the other terminal on the primary side of the transformer 2 connected to the output side of the alternate current signal amplifying medium 1.

Then, the pattern 27 is mounted to the backside of the substrate, in order to play a role of the feedback circuit 4. To be more concrete, the pattern 27 is connected to the input side of the alternate current signal amplifying medium 1, and on the other hand, is provided with a capacitive coupling portion 24 that faces opposite to a part of the pattern 21 across the substrate. As a result, the pattern 27 can achieve a capacitive coupling to the pattern 21.

In accordance with the above-mentioned configuration, a capacity that is generated between the pattern 27 and the pattern 21 corresponds to a symbol “C1” in FIG. 6A; and a capacity that is generated between the pattern 27 and the ground pattern (and that generally exists as a floating capacitance) corresponds to a symbol “C2” in the same manner. Therefore, without actually installing the capacitive elements, the voltage can be divided.

Now, the state of voltage division in accordance with such pattern arrangement will be described concretely. FIG. 6C illustrates a state of the capacitive coupling portion 24 in three dimensions. As shown in this figure, a symbol “x” denotes the length of the capacitive coupling portion 24 that is overlapped over the pattern 21 in the pattern 27; a symbol “y” denotes the width thereof, and a symbol “d” denotes the thickness of the substrate. Here, the capacity C1 that is generated by the pattern 27 (the capacitive coupling portion 24) and the pattern 21 can be expressed as:

C1=εₒ×ε×x×y/d

where a symbol “εₒ” denotes a permittivity of vacuum, and a symbol “ε” denotes a relative permittivity of the substrate, respectively.

Therefore, when the “x” is 1 mm, “y” is 0.3 mm, “d” is 0.6 mm, and “ε” is 2, “εₒ” will be “8.85418782×10⁻¹²[m-3 kg-1 s4 A2],” so that “C1” will be approximately “9×10⁻³ pF.” In addition, when the floating capacitance C2 (the capacity that is generated between the pattern 27 and the ground pattern) of the pattern 27 is set to be “1 pF,” the voltage dividing ratio in the voltage dividing circuit will be “C1/(C1+C2) ≈0.01.” Therefore, the voltage of the pattern 21 can be divided to be approximately 1/100 so as to be fed back.

The voltage dividing ratio can be set to be an optional value by adjusting the capacity C1. Therefore, it is possible to set the voltage being fed back to take a desired level. Adjustment of the capacity C1 can be performed by adjusting the relative permittivity (ε) of a substrate material and the thickness (d) of the substrate. In addition, in accordance with the present configuration, since both surfaces of the substrate can have patterns mounted thereon, it is easy to reduce the substrate area and downsize the substrate. When such an inequity exists as “C1<<C2,” the above-mentioned voltage dividing ratio can be regarded as “C1/C2,” and in this case, the voltage dividing ratio can be thought to be proportional to “ε/d.”

Additionally, instead of the configuration of the substrate as shown in FIG. 6B, the substrate pattern 27 may be mounted to the front surface of the substrate (to the side where the pattern 21 is mounted). The configuration of the substrate in such a manner as has been described is shown in FIG. 6D.

In accordance with the present configuration, the capacitive coupling portion 24, which is a part of the pattern 27, and the pattern 21 are mounted so as to be parallel to each other, and thereby, a capacitive coupling is performed. Same as the configuration shown in FIG. 6B, in accordance with the present configuration, a voltage can be divided without actually mounting the capacitive elements.

In accordance with the configuration of the substrate as shown in FIG. 6D, the area of the capacitive coupling portion 24 may be adjusted by providing the capacitive coupling portion 24 with a specification which makes it possible to bridge or cut the capacitive coupling portion 24. The configuration of the substrate in this case is shown in FIG. 6E.

As shown in this figure, the capacitive coupling portion 24 includes a first part 24a, a second part 24b, and a third part 24c. The parts 24a through 24c are isolated from each other (so as not to be electrically connected), and are also mounted so as to be parallel to the pattern 21 as a whole.

In accordance with the present configuration, by bridging (connecting) the parts by a solder and the like in a space between the parts, it is possible to increase the capacities of the capacitive coupling portion 24 and the pattern 21. FIG. 6E shows a state in which the first part 24a and the second part 24b are bridged by the solder 29.

In addition to bridging for an increase in the capacity, for example, a part of the capacitive coupling portion 24 may be cut off freely, thereby making it possible to decrease the capacities of the capacitive coupling portion 24 and the pattern 21. As described hereinabove, when the capacities of the capacitive coupling portion 24 and the pattern 21 can be adjusted, as appropriate a voltage output as possible can be achieved by adjusting the capacities so as to have the level of an input signal from the alternate current signal amplifying medium 1 take an appropriate value, although there is a variation of the output voltage due to a variation of the properties of the components that construct the voltage output device.

As has been described hereinabove, a configuration that makes it possible to adjust the capacities of the capacitive coupling portion 24 and the pattern 21 can be applied to the configuration shown in FIG. 6B in which the substrate pattern 27 is mounted on the surface on the opposite side of the substrate pattern 21. Such a configuration of the substrate is shown in FIG. 6F.

The tangible configurations of the substrate that can divide the voltage without having the capacitive elements actually installed by adopting an arrangement (a combination) of the substrate patterns that generate the electric capacities have been described hereinabove. However, concrete embodiments are not limited to the above. For example, an explanation has been given to a configuration in which the patterns 21 and 27 are in parallel, but they may be diagonal patterns or circle patterns. By adjusting the size, the length, the distance and the like of the patterns appropriately, an object of the present invention can be achieved. This is the same for a configuration in which the patterns are mounted on the surfaces on both sides. Moreover, the patterns on both surfaces may not be in parallel, but they may be misaligned vertically, or may be crossed perpendicularly or diagonally.

Now, description will be back to the explanation about the operations of the ion generator. An alternate current signal that is fed back has the voltage level thereof amplified by the alternate current signal amplifying medium 1 so as to be produced. As described hereinabove, the ion generator in accordance with the present embodiment constructs a self-excited oscillation circuit by a closed circuit comprising an alternate current signal amplifying medium 1, a transformer 2, a voltage lowering circuit 3, and a feedback circuit 4. The oscillation frequency thereof is approximately same as the resonance frequency of the resonance circuit that is formed by the secondary side coil of the transformer 2 and the capacitor of the ion generating elements 5.

To be specific, the voltage that is fed back by the feedback circuit 4 is amplified by the alternate current signal amplifying medium 1, with maintaining the frequency thereof almost as it is, and fed to the primary side coil of the transformer 2. In addition, the voltage that is fed back by the feedback circuit 4 is fed to the primary side coil of the transformer 2 with maintaining the phase thereof almost as it is (when the input and the output of the transformer 2 have the same phase). It can be postulated that the phase may be reversed by the transformer 2, depending on the winding direction of the transformer 2. However, for example, by providing a phase changer to the feedback circuit 4 so as to have the phase reversed further, oscillation will be possible.

By repeating the above-mentioned operations, voltage fluctuations immediately after the electric power is supplied gradually grow until the maximum voltage magnitude that can be produced by the output terminal of the alternate current signal amplifying medium 1, and thereby, oscillation is maintained. The frequency of this oscillation is approximately equivalent to the resonance frequency (the frequency at which the maximum voltage is obtained) of the resonance circuit that is formed by the ion generating elements 5 and the secondary side coil of the transformer 2.

By the above-mentioned operation, a high voltage can be obtained efficiently on both ends of the ion generating elements 5. Additionally, even when the capacities of the ion generating elements 5 vary due to a change in the atmospheric humidity, or an access of a conductive object, or the like, due to a series of the aforementioned operations, it is possible to obtain an alternate current voltage having a frequency, which always sets the voltages on both ends of the ion generating elements 5 at the maximum level, whereby high efficiency is maintained.

Now, the verification results of effects of the present embodiment will be described hereinafter. In a case where general-purpose components are employed to construct a circuit, considering a change in the temperature, the range of the variation of the component constant is within “±20%.” When all the values of the circuit constructing components R, C, and L were changed for “±20%,” the fluctuations in the output voltage were verified to be within “±5%” by using a circuit simulator (OrCAD).

Furthermore, after preparing an evaluation board, alternate current signals being applied to both ends of the ion generating elements were measured by using a high pressure probe (Tektronix Co. P6015A) and a storage oscilloscope (HP Co. 54825A) housing a built-in function of frequency counter. As a result, it was observed that the voltage being applied to the both ends of the ion generating elements at the frequency of the alternate current signals was at the maximum, and it was also observed that the ions were generated efficiently, almost without being affected by a variation of the components in actual application, but with the highest voltage always applied to the both ends of the ion generating elements.

### Second Embodiment

By referring to the drawings, a second embodiment of an ion generator in accordance with the present invention will be concretely described hereinafter. Basically, the present embodiment has a same configuration as the first embodiment, excluding a point that an alternate current signal producing medium 101 is provided in place of an alternate current signal amplifying medium 1, so that overlapped description will be omitted.

FIG. 7 is a block diagram showing an overview of an ion generator in accordance with the present embodiment. As shown in this figure, an ion generator comprises an alternate current signal producing medium 101, a winding transformer (a voltage raising medium) 2, a voltage lowering medium (a voltage dividing circuit) 3, a feedback circuit 4, and ion generating elements 5, and the like. To be specific, instead of the alternate current signal amplifying medium 1 in accordance with the first embodiment, the alternate current signal producing medium 101 is employed thereto.

The alternate current signal producing medium 101 is a circuit that is provided with a voltage being fed back (a feedback voltage) from the secondary side coil of the transformer 2 by way of the feedback circuit 4, and produces an alternate current signal (an alternate current voltage) having the same frequency as the feedback voltage so as to be produced to the primary side coil of the transformer 2. In addition, as described hereinafter, the alternate current signal producing medium 101 also has a function to feed a voltage having a resonance frequency to the resonance circuit by the secondary side coil of the transformer 2 and the ion generating elements 5 so as to obtain information on the resonance frequency based thereon. Concrete configuration of the alternate current signal producing medium 101 will be described again.

To be specific, in accordance with the first embodiment, a voltage having the resonance frequency is fed to the primary side coil of the transformer 2 by amplifying the feedback voltage itself (mainly consisting of the resonance frequency component of the resonance circuit on the secondary side of the transformer 2). However, in accordance with the second embodiment, the feedback voltage is treated as information for obtaining a resonance frequency, and a voltage being at a same level as the resonance frequency is produced, based on this information, so as to be fed to the primary side coil of the transformer 2.

Therefore, in accordance with the first embodiment, it is possible to simplify the configuration of the circuit for feeding a voltage of the resonance frequency to the primary side of the transformer 2; while in accordance with the second embodiment, it is possible to feed a voltage of the resonance frequency to the primary side of the transformer 2 more stably. To be specific, once the resonance frequency is properly obtained, it is easy to continue to feed a voltage of the resonance frequency to the primary side coil of the transformer 2 even when a noise is mixed into a feedback voltage subsequently.

Next, an example of a concrete configuration of an ion generator is shown in FIG. 8. As shown in this figure, the alternate current signal producing medium 101 comprises a first pulse producing portion 102, a waveform shaping portion 103, a frequency measuring portion 104, a frequency memory portion 105, a second pulse producing portion 106, and a signal switching-over portion 107, and the like. In addition, the signal switching-over portion 107 connects either of the first pulse producing portion 102 and the second pulse producing portion 106 to the primary side coil of the transformer 2, so as to be switchable. This switching-over operation is controlled by a control medium that is not illustrated herein.

Moreover, portions such as the transformer 2, the voltage dividing circuit 3, and the like, have same configuration as shown in FIG. 6D in the description of the first embodiment. Then, the feedback circuit 4 has rectifying elements (diodes) 108 mounted so as to be arranged, with the secondary side of the transformer 2 serving as an anode, and with the alternate current signal producing medium 101 serving as a cathode.

Furthermore, a symbol “L1” herein denotes a power source line that supplies the electric power to the alternate current signal producing medium 101, and a symbol “L2” denotes a ground line (a reference potential line). A number “11” denotes a first terminal that is connected to an output on the secondary side of the transformer 2, being a terminal that connects one side of the electrodes of the ion generating elements. A number “12” denotes a second terminal that is connected to the ground line (the reference potential line) of zero volt, being a terminal that connects the other side of the electrodes of the ion generating elements.

Next, the content of the operations of the ion generator (especially, the operation in shifting from a stopping state to a driving state) will be described hereafter. For example, when a voltage V1 is applied to the alternate current signal producing medium 101 by way of the power source line L1 in accordance with a user's direction, first, the first pulse producing portion 102 produces a single pulse having an appropriate pulse width W as shown in FIG. 9A (that has a frequency component of a wide band which is broad enough to contain a same component as an assumed resonance frequency on the secondary side of the transformer 2). At this point, the signal switching-over portion 107 has the first pulse producing portion 102 connected to the transformer 2.

Therefore, a single pulse being produced is fed to the primary side coil of the transformer 2 by way of the points G and B in FIG. 8. For this input of the single pulse, the resonance circuit on the secondary side of the transformer 2 starts resonance, when in the front stage of a rectifying element 108 (a point A in FIG. 8) in the feedback circuit 4, a signal waveform (a damping waveform) that is damped at the resonance frequency is produced as shown in FIG. 9C. To be specific, by an action of the resonance circuit, such a frequency component among the frequency components being contained in the single pulse, as is approximately same as the resonance frequency, continues to exist and show up as such a damping waveform as described hereinabove.

In the rear stage of the rectifying element (a point F in FIG. 8) in the feedback circuit 4, a rectifying waveform that feeds a voltage only in a positive direction is produced as shown in FIG. 9D. Then, the rectifying waveform is fed to the waveform shaping portion 103, so as to be digitalized (formed into a pulse wave). In addition, the frequency measuring portion 104 includes a timer inside thereof, and measures the pulse width T of a signal being digitalized by the waveform shaping portion 103. Measurement of the pulse width can be taken, for example, by monitoring a timing to detect an edge at which an input waveform rises, and measuring an interval of the timings.

A frequency f (Cycle T=1/f) being measured by the frequency measuring portion 104 is memorized in the frequency memory portion 105. After that, the second pulse producing portion 106 reads out the frequency f (Cycle T=1/f) being memorized in the frequency memory portion 105, and produces a pulse signal (an alternate current signal) which is successive in a cycle T as shown in FIG. 9B. In addition, the pulse width of this alternate current signal is, for example, “T/2;” and the amplitude (the level) of the alternate current signal fluctuates in accordance with the level of the voltage V1.

When the second pulse producing portion 106 produces successive pulse signals, the signal switching-over portion 107 is switched over to be placed in a condition to have the second pulse producing portion 106 connected to the transformer 2. Therefore, the alternate current signal is fed to the input side (a point B in FIG. 8) of the primary side coil of the transformer 2. Subsequently, the second pulse producing portion 106 continues to feed such alternate current signals to the primary side of the transformer 2.

At this point, the alternate current signals are adjusted so as to have the same frequency as the feedback voltage by the processes that are performed in the pathway from the rectifying element 4 to the second pulse producing portion 106, so that a frequency thereof will be the same as the resonance frequency on the secondary side of the transformer 2. As a result, a voltage having the same frequency as the resonance frequency is fed to the transformer 2.

Moreover, the processes being supplied by the waveform shaping portion 103 and the frequency measuring portion 104 in the alternate current signal producing medium 101 are executed only for the feedback signals against the single pulses that are produced by the first pulse producing portion 102, and are not executed after the second pulse producing portion 106 produces successive pulses.

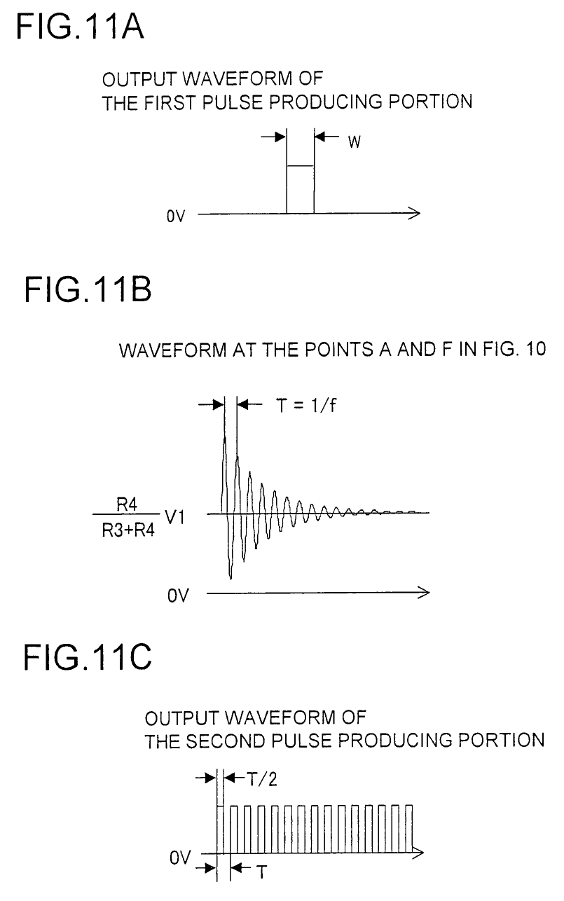

Another embodiment of the ion generator shown in FIG. 7 will be described hereinafter by referring to FIG. 10. Basically, the configuration of the ion generator in FIG. 10 has the same configuration as the ion generator shown in FIG. 8, excluding a point that the resistance elements R3 and R4 (resistances for bias) are mounted, instead of omitting an installation of the rectifying element 108.

The content of the operations of the ion generator (especially, the operation shifting from a stopping state to a driving state) will be described, hereafter. For example, when a voltage V1 is applied to an alternate current signal producing medium 101 by way of the power source line L1 in accordance with a user's direction, first, the first pulse producing portion 102 produces a single pulse having an appropriate pulse width W as shown in FIG. 11A. At this point, the single switching-over portion 107 has the first pulse producing portion 102 connected to the transformer 2.

Therefore, a single pulse being produced is fed to the primary side of the transformer 2 by way of points G and B in FIG. 10. For this input of the single pulse, a resonance circuit on the secondary side of the transformer 2 starts resonance. Therefore, in the feedback circuit 4 (points A and F in FIG. 10), as shown in FIG. 11B, a signal waveform (a damping waveform) that is damped at the resonance frequency is produced in a condition that a bias voltage [R4/(R3+R4)×V1] is applied. In addition, the value of the voltage V1 and the resistance values of the resistance elements (R3 and R4) are set appropriately in a manner that the voltage in a damping waveform with a bias voltage added takes only a positive value.

Then, the damping waveform having a bias voltage added thereto is fed to the waveform shaping portion 103, so as to be digitalized (formed into a pulse wave). In addition, the frequency measuring portion 104 includes a timer inside thereof, and measures the pulse width T of a signal that is digitalized by the waveform shaping portion 103. Measurement of the pulse width can be taken, for example, by monitoring a timing to detect an edge at which an input waveform is rises, and measuring an interval of the timings.

The frequency f (Cycle T=1/f) being measured by the frequency measuring portion 104 is memorized in the frequency memory portion 105. After that, the second pulse producing portion 106 reads out the frequency f (Cycle T=1/f) being memorized in the frequency memory portion 105, and produces a pulse signal (an alternate current signal) which is successive in a cycle T as shown in FIG. 11C. In addition, the pulse width of this alternate current signal is , for example, “T/2,” and the amplitude of the alternate current signal fluctuates in accordance with the level of the voltage V1.

When the second pulse producing portion 106 produces an alternate current signal, the signal switching-over portion 107 is switched over to be placed in a condition to have the second pulse producing portion 106 connected to the transformer 2. Therefore, the alternate current signal is fed to the input side (a point B in FIG. 10) of the primary side coil of the transformer 2. Subsequently, the second pulse producing portion 106 continues to feed such alternate current signals to the primary side coil of the transformer 2.

At this point, the alternate current signals are adjusted to have the same frequency as a feedback voltage by the processes that are performed in the pathway from the waveform shaping portion 103 to the second pulse producing portion 106, so that a frequency thereof will be the same as the resonance frequency on the secondary side of the transformer 2. As a result, a voltage having the same frequency as the resonance frequency is fed to the transformer 2.

Moreover, the processes being supplied by the waveform shaping portion 103 and the frequency measuring portion 104 in the alternate current signal producing medium 101 are executed only for the feedback signals against the single pulses that are produced by the first pulse producing portion 102, and are not executed after the second pulse producing portion 106 produces successive pulses.

As described hereinabove, the ion generator in accordance with the present embodiment has been explained, taking two concrete examples of configuration. However, other configurations may be applied thereto. For example, the above-mentioned examples of configuration employ a circuit configuration shown in FIG. 6D as the transformer 2 and the voltage lowering medium 3. Instead, any of the circuit configurations shown in FIGS. 6B, 6E and 6F (all of which have been explained in the description of the first embodiment, and thereby, the detailed explanation thereof will be omitted,) may be adopted. In addition, the configuration of the voltage lowering medium 3 is not limited to a voltage dividing circuit that employs a plurality of capacitive elements, but may adopt a voltage dividing circuit that employs a plurality of resistance elements in a same manner as shown in FIG. 2.

Moreover, the alternate current signal producing medium as a method to detect a resonance frequency is not limited to such as described hereinabove, but may have other methods applied. For example, the alternate current signal producing medium may detect a frequency component that has the largest amplitude in the voltages being fed back from the resonance circuit on the secondary side of the transformer 2, and may feed an alternate current voltage, having the same frequency as the frequency component being detected, to the primary side coil of the transformer, serving as an alternate current signal.

### Third Embodiment

The ion generator in accordance with the above-mentioned first embodiment can adjust the output voltage to the ion generating elements 5 by adjusting the level of the supply voltage V1 to the alternate signal amplifying medium 1; and the ion generator in accordance with the second embodiment can adjust the output voltage to the ion generating elements 5 by adjusting the level of the supply voltage V1 to the alternate signal producing medium 101. Therefore, the ion generators in accordance with the first and the second embodiments can generate not only the ions but also the ozone, by adjusting the level of the supply voltage V1, whereby the ion generators can serve as an ion/ozone generator

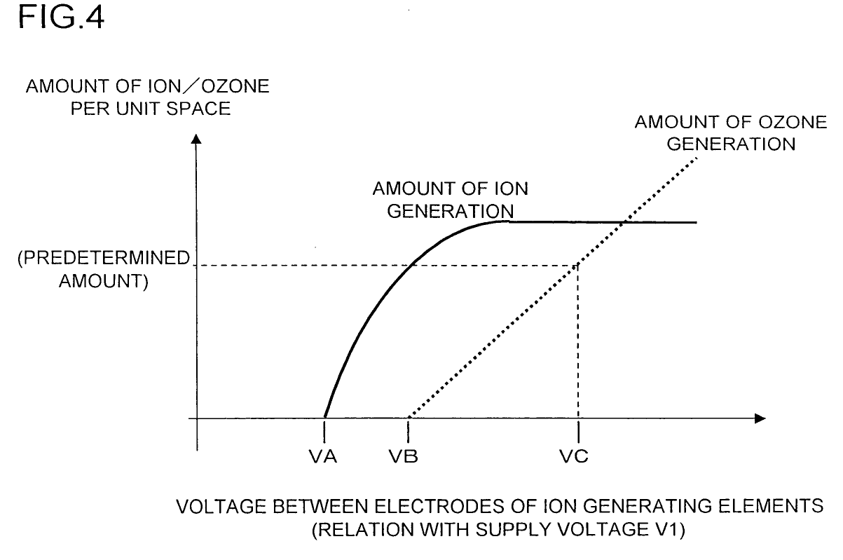

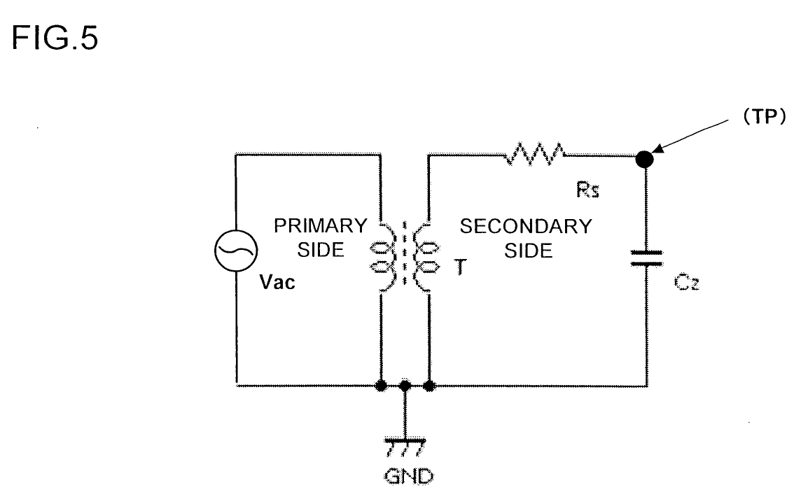

Now, a third embodiment in accordance with the present invention will be described hereinafter by referring to an ion/ozone generator. First, FIG. 4 shows an example of a diagram indicating a relationship between the voltage between the ion generating elements (or the voltage amplification ratio in the alternate current signal amplifying medium 1, the level of an alternate current signal being fed by the alternate current signal amplifying medium 101, or a supply voltage V1) and the amount of generation of the ions and ozone.

Characteristics of generation of the ions and the ozone depend on the structure of the ion generating elements, the waveform of a high voltage being applied to the ion generating elements, the amount of molecules of the water vapor and the like existing in the air, and the like, but the tendency thereof is approximately as shown in FIG. 4. Since the amount of ion generation is limited by the amount of the molecules of the water vapor and the like existing in the air, the amount of generation is saturated at a certain level of the voltage. Therefore, as shown in FIG. 4, there is a tendency that in a range in which the voltage being applied to the ion generating elements is low, the amount of the ion generation is larger than the amount of the ozone generation; while in a region in which the applied voltage is high, the amount of the ozone generation is larger than the amount of the ion generation.

Therefore, the ion/ozone generator in accordance with the present embodiment can change over the amount of the ion and ozone generation by utilizing this tendency. This changing-over can be achieved by providing a variable voltage power source 42 and an ion output control portion 43.

The variable voltage power source 42 makes a supply voltage V1 to the alternate signal amplifying medium (in a case of the first embodiment) or to the alternate current signal producing medium 101 (in a case of the second embodiment) be variable by a voltage adjusting medium. This voltage adjusting medium can be practically offered, for example, by an element such as a transistor, and the like. In addition, by fluctuating the supply voltage V1, the voltage amplification ratio in the alternate current signal amplifying medium 1, or the amplitude of an alternate current signal to be fed by the alternate current signal producing medium 101 is changed (switched over), accordingly.

Additionally, the ion output control portion 43 controls the amount of generation of the ions or the ozone through adjustment being made in the above-mentioned voltage adjusting media. Various types of control methods can be employed, and an example thereof will be described hereinafter.

The ion output control portion 43 selects operation modes in the ion/ozone generator, alternatively. To be concrete, for example, the operation modes include a mode to generate the ions without generating the ozone (a first operation mode), a mode to generate less ozone than a predetermined amount (a second operation mode), a mode to generate more ozone than the predetermined amount (a third operation mode), and a mode to generate neither ions nor ozone (a fourth operation mode).

In addition, for example, since a large amount of the ozone has adverse effects on human bodies, it is considered that an amount being a threshold value for having an adverse effect on a human body or not can be used as this “predetermined amount” associated with the amount of the ozone generation. As a result, the first operation mode can respond to a case in which sterilization and bacteria elimination, and the like are performed while adverse effects on human bodies are restrained to be minimum; the second operation mode can respond to a case in which there is a possibility that the ozone may come to contact with a human body although power actions of sterilization and bacteria elimination are asked for to some degree; and the third operation mode can respond to a case in which the ozone has no possibility to come to contact with a human body, and more powerful actions of sterilization and bacteria elimination are asked for, respectively.

For example, as shown in FIG. 4, when a voltage at a time when the ion begins to be generated (a voltage between the electrodes of the ion generating elements) is “VA,” a voltage at a time when the ozone begins to be generated is “VB,” and a voltage at a time when the ozone is generated for a predetermined amount is “VC”, the voltage between the electrodes of the ion generating elements is pre-set to take any of the values from VA to VB in the first operation mode; is pre-set to take any of the values from VB to VC in the second operation mode; is pre-set to take a larger value than VC in the third operation mode; and is pre-set to take a smaller value than VA, respectively.

As described hereinabove, since the characteristics of the ion and the ozone generations are influenced by the configuration of the ion generating elements and by the waveform of a high voltage to be applied to the ion generating elements, it is necessary to determine the supply voltage in each operation mode, taking these factors into consideration. In addition, similarly, since the characteristics of the ion and the ozone generations depend on the amount of molecules of the water vapor and the like existing in the air, it is further preferable that the ion/ozone generator can follow this change in the amount of the molecules existing in the air. For example, such an ion/ozone generator can possibly be offered as has a device for measuring the amount of molecules of the water vapor so that it can correct the supply voltage corresponding to each of the operation modes, depending on the measurement results.

Moreover, it is possible to select which operation mode to take, by corresponding to a user's key operation, and the like, for example. To be specific, four push-button keys corresponding to the operation modes, respectively, are provided for the user's interface; and the voltage amplification ratio of the alternate current signal amplifying medium 1, or the level of an alternate current signal being produced by the alternate current signal producing medium 101, either of which is necessary for putting the operation modes into practice, is calculated in advance.

Then, when any of the push-button switches is depressed, the alternate current signal amplifying medium 1 may be changed over to take a voltage amplification ratio corresponding to the push-button switch, or an alternate current signal being fed by the alternate current signal producing medium 101 may be changed over to be at a level corresponding to the push-button switch. For example, when the push-button switch corresponding to the second operation mode is depressed, the supply voltage V1 to the alternate current signal amplifying medium 1 or to the alternate current signal producing medium 101 is changed over, so that the voltage amplification ratio that is pre-calculated so as to make the voltage between the electrodes of the ion generating elements take any of the values from VB to VC, or so that the level of the alternate current signal will be taken.

By changing over the voltage amplification ratio of the alternate current signal amplifying medium 1 or the level of an alternate current signal being produced by the alternate current signal producing medium 101, a voltage being fed from the secondary side of the transformer (a high voltage output device) is changed over; and the amounts of the ion generation and the ozone generation depend on the voltage between the both electrodes of the ion generating elements that are arranged by way of the air. Therefore, by adjusting the voltage amplification ratio of the alternate current signal amplifying medium 1 or the level of an alternate current signal being fed by the alternate current signal producing medium 101, the amounts of the ion generation and the ozone generation can be easily controlled, and at the same time, by executing such control in accordance with the state of the time, an ion generator having a high versatility is practically offered.

Moreover, since a control state is set alternatively by selecting from four operation modes by a switching-over medium, it is possible to easily generate the ions and the ozone corresponding to the state of the time.

### Fourth Embodiment

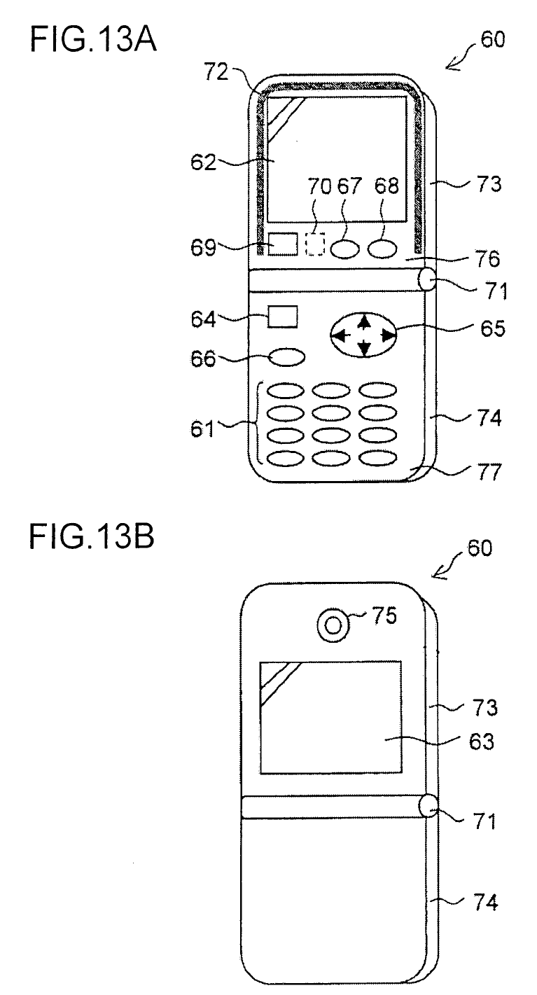

Next, an embodiment of a cellular phone being provided with an ion generator will be described as a fourth embodiment. FIGS. 13A and 13B are perspective views showing a cellular phone unit 60 in accordance with the present embodiment. A cellular phone unit 60 is a fordable type of cellular phone unit, so that the cellular phone unit 60 can be folded by way of a commonly-known rotating mechanism 71 including a hinge, and the like. The state of the cellular phone unit 60 can freely shift between a state in which the cellular phone unit 60 is opened (in a state in which the cellular phone unit 60 is not folded) and a state in which the cellular phone unit 60 is closed (in a state in which the cellular phone unit 60 is folded) by an external force that is applied by an operator.

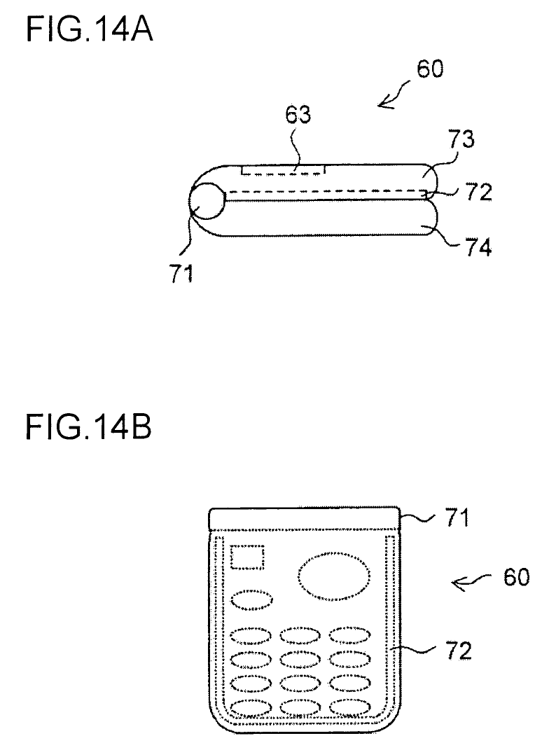

FIG. 13A is a perspective view showing a front surface of the cellular phone unit 60 when the cellular phone unit 60 is opened so as to have the display content and the like of a main display portion 62 confirmed; and FIG. 13B is a perspective view showing a back surface of the cellular phone unit 60 in such a condition as has been described above. FIG. 14A and FIG. 14B are view showing a side surface and a top surface of the cellular phone unit 60 when the cellular phone unit 60 is closed. In FIG. 14B, in order to prevent complication of a diagram, illustration of a sub-display portion 63, and the like is omitted.

The cellular phone unit 60 comprises an operation keys 61, a main display portion 62, a sub-display portion 63, a finger mark sensor 64, a position selecting key 65, an ion generation operation mode setting key 66, an ion generation voltage raising key 67, an ion generation voltage lowering key 68, ion ejecting portion 69, an ion generator 70, a hinge (rotating) mechanism 71, a shock mitigating member 72, an upper enclosure 73, a lower enclosure 74, and an image sensing portion 75. The rotating mechanism 71, the upper enclosure 73 and the lower enclosure 74 construct an enclosure of the cellular phone unit 60, wherein the upper enclosure 73 and the lower enclosure 74 are separated with the rotating mechanism serving as a border. (However, the upper enclosure 73 and the lower enclosure 74 are connected electrically).

An upper enclosure surface 76 of the upper enclosure 73 has the main display portion 62, the ion generation voltage raising key 67, the ion generation voltage lowering key 68, the ion ejecting portion 69, and the shock mitigating member 72 provided thereto. In addition, the upper enclosure 73 has the ion generator 70 installed to the inside thereof

A lower enclosure surface 77 of the lower enclosure 74 has the operation keys 61, the finger mark sensor 64, the position selecting key 65, and the ion generation operation mode setting key 66 provided thereto. A back surface 78 of the upper enclosure 73 has the sub-display portion 63 and the image sensing portion 75 mounted thereto.

The operation keys 61, the finger mark sensor 64, the position selecting key 65, the ion generation operation mode setting key 66, the ion generation voltage raising key 67 and the ion generation voltage lowering key 68 are contact type information input portions with which a person, who is an operator, comes to contact directly so as to input information. Among the contact type information input portions, the finger mark sensor 64 is a biometric information input medium that receives an input of biometric information for performing biometric certificate, and in other cases than the aforementioned, serves as a key input medium that receives information being assigned to the keys by a key operation being performed by fingertips and the like. The main display portion 62 and the sub-display portion 63 may be referred as components that feed information in such a feature as a person can recognize.

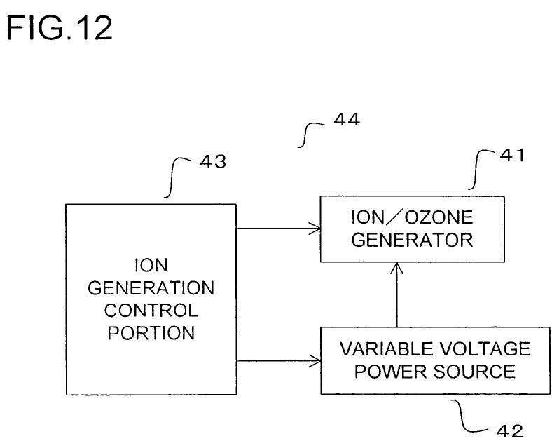

The ion generator that has been disclosed as the first embodiment or the second embodiment or an ion/ozone generating system 44 (FIG. 12) that has been disclosed as the third embodiment can be employed as the ion generator 70. The ion/ozone generating system 44 (FIG. 12) being employed as the ion generator 70 will be described hereinafter. The ions that are generated by the ion generator 70 are fed to the upper enclosure surface 76 of the upper enclosure 73 from the ion ejecting portion 69 that is an opening being provided to the upper enclosure surface 76.

The shock mitigating member 72 is made of a rubber member, and is fixed on a circumference of the upper enclosure surface 76, being shaped in an approximately square, so as to surround a region in which the main display portion 62, the ion generation voltage raising key 67, the ion generation voltage lowering key 68, and the ion ejecting portion 69 are mounted. For example, the above-mentioned region can be regarded as a square region. The shock mitigating member 72 is shaped in a gate (in a square with one side excluded), and three sides of the above-mentioned region are surrounded by the shock mitigating material 72, and the remaining one side is surrounded by a member of the rotating mechanism 71 (a hinge mechanism). The material of the shock mitigating member 72 is not limited to a rubber member, but other materials may be employed.

Then, when the cellular phone unit 60 is closed (folded), as shown in FIG. 14A and FIG. 14B, the shock mitigating member 72 is closely attached to the circumference of the lower enclosure surface 77, and thereby, an approximately rectangular solid space that is surrounded by the upper enclosure surface 76, the lower enclosure surface 77, the shock mitigating member 72, and a member of the rotating mechanism 71 is put into a sealed state.

This space includes the main display portion 62, the ion generation voltage raising key 67, the ion generation voltage lowering key 68 and the ion ejecting portion 69 that exist on the upper enclosure surface 76, and the operation keys 61, the finger mark sensor 64, the position selecting key 65, and the ion generation operation mode setting key 66 that exist on the lower enclosure surface 77. Of course, when the cellular phone unit 60 is opened, the above-mentioned space is opened.

In addition, a “sealed state” herein is not necessarily limited to a state being completely sealed, but may be a state in which the space is nearly filled with the ions or the ozone although a little gap exists. For example, between the shock mitigating member 72, and the lower enclosure surface 77 or the hinge mechanism 71, a little gap is easy to occur, but sufficient favorable effect can be expected as long as the space can be almost filled with the ions or the ozone.

Moreover, the shock mitigating member 72 may be shaped in a square having four sides (being not illustrated) instead of being shaped in a gate having three sides. To be specific, when the cellular phone unit 60 is closed, by having the shock mitigating member 72 in a shape of a square attached closely to the circumference of the lower enclosure surface 77, the above-mentioned space may be put into a sealed state by the shock mitigating member 72 in a shape of a square, the upper enclosure surface 76, and the lower enclosure surface 77 (without depending on the member of the rotating mechanism 71).

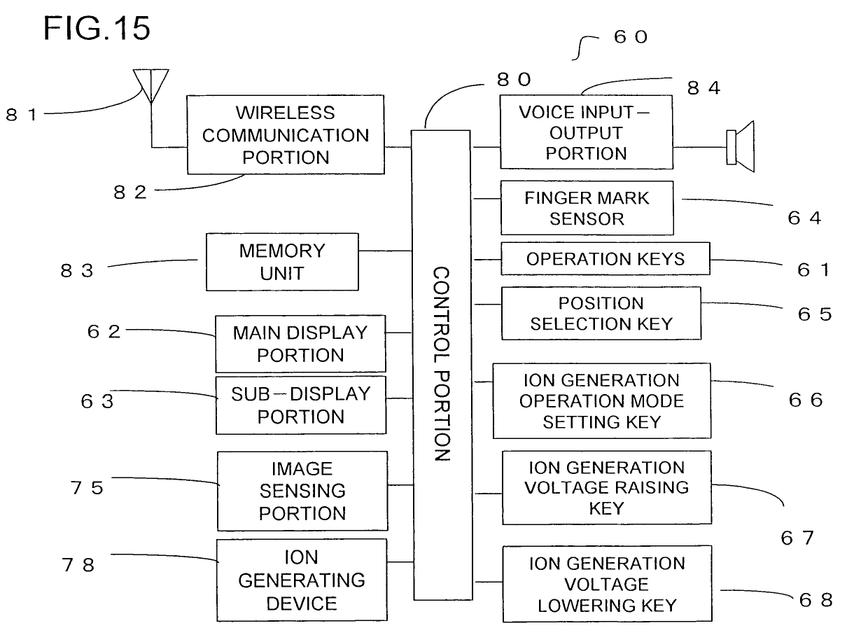

FIG. 15 is a block diagram showing the functions of the cellular phone unit 60. In FIG. 13A, FIG. 13B, FIG. 14A, FIG. 14B and FIG. 15, same symbols are supplied to the same portions. The cellular phone unit 60 further comprises a control portion 80, an antenna 81, a wireless communication portion 82, a memory unit 83 and a voice input-output portion 84, in addition to the portions that have been described by referring to FIG. 13. The control portion 80 can detect whether the cellular phone unit 60 is closed or opened, by employing a switch (being not illustrated) that is turned on and off in accordance with the opening and closing operations of the cellular phone unit 60.

The operations of the cellular phone unit 60 will be described hereinafter. When the cellular phone unit 60 shifts from a standby state to an operation state in which communication and image sensing are possible, (to be specific, when the cellular phone unit 60 shifts from the closed state to the open state), a control signal is fed from the control portion 80 to an ion generation control portion 43 (FIG. 12) of the ion generator 70 in order to generate the ions. As a result, the power source of the ion/ozone generator 41 (FIG. 12) is turned on, (to be specific, put in the ion generation mode by having a direct current voltage V1 fed to the power source line L1), and thereby, the ions are fed from the ion ejecting portion 69.

In addition, when the cellular phone unit 60 is placed in the operation state, the cellular phone unit 60 is put in the open state as shown in FIG. 13A and FIG. 13B. Moreover, when the cellular phone unit 60 is in the standby state, the cellular phone unit 60 is put in the closed state as shown in FIG. 14A and FIG. 14B.

Then, when the ions are fed for a predetermined time, a control signal is fed from the control portion 80 to the ion generation control portion 43 (FIG. 12) of the ion generator 70 in order to stop the ion generation. As a result, the power source of the ion/ozone generator 41 is turned off, (to be specific, the supply of the direct current voltage V1 to the power source line L1 is shut off), and the ion generation is stopped. The ions can kill bacteria floating in the surroundings of the cellular phone unit 60. Additionally, when the cellular phone unit 60 is used among many people, the cellular phone unit 60 can be used, being sterilized by the ions.

It has been described that after shifting from the standby state to the operation state, the power source of the ion/ozone generator 41 is turned off after a predetermined time has passed. However, the ions may continue to be fed after the standby sate is shifted to the operation state. In this case, for example, when the cellular phone unit 60 is put into the standby state (in the standby mode) again and folded, the power source of the ion/ozone generator 41 is shifted from being turned on to off.

In order to enhance the sterilizing effect, the ozone may be generated together with the ions, and the ozone may be fed from the ion ejecting portion 69. However, considering ozone fumes and adverse effects of a large amount of the ozone on the human bodies, the amount of the ozone generation is controlled in an appropriate manner. The amount of the ozone generation can be controlled by increasing or decreasing the voltage to be applied to the ion generating elements.

When the cellular phone unit 60 is shifted from the operation state to the standby state, (to be specific, when the cellular phone unit 60 is shifted from the open state to the closed state), a control signal is fed from the control portion 80 to the ion generation control portion 43 (FIG. 12) of the ion generator 70 so as to generate the ozone. As a result, the supply voltage to the ion/ozone generator 41 (FIG. 12) is raised, (to be specific, in the ozone generation mode by having the power source line L1 in FIG. 2 supplied with a voltage that is raised to be a direct current voltage at which the ozone is generated), and the ozone is fed from the ion ejecting portion 69. At this time, the ions may be generated together with the ozone, and both may be fed from the ion ejecting portion 69.

After a predetermined time passes, the power source of the ion/ozone generator 41 shifts from ON to OFF, and then shifts to the ion generation stop mode until the operation of the ion/ozone generation system 44 stops. In addition, feeding of the ozone or feeding of the ozone and the ions from the ion ejecting portion 69 may continue until the cellular phone unit 60 shifts to the open state again.

Since the ozone is supplied to the above-mentioned sealed space including the operation keys 61, and the like, with the cellular phone unit 60 put in the closed state (in the folded state), the ozone is confined in the above-mentioned space for a longer time than in an unsealed space. As a result, the sterilizing effect of the ozone can continue longer, thereby achieving effective sterilization. Therefore, convenience thereof can be enhanced for such cases as a case where the cellular phone unit 60 is used in turns by a plurality of operators; a case where the cellular phone unit 60 is used at such a place as a medical institution and the like especially requiring hygienic consideration; and the like.

The ions have an effect to electrically neutralize dusts, dirt, and the like that are attached to the operation keys 61 and the like by charging so as to easily get rid of the dusts and the like. Therefore, by supplying the ions to the above-mentioned sealed space with the cellular phone unit 60 put in the closed state (in the folded state), the dusts and the like are easy to be cleared off.

In addition, when the ozone is generated, the state of generation thereof may be displayed in the sub-display portion 63; and when the ion is generated, the state of generation thereof may be displayed in the main display portion 62. As a result, the operators can confirm the states of the ion generation and the ozone generation.

Moreover, when the cellular phone unit 60 shifts from the operation state (the open state) to the standby state (the closed state), and the power source of the ion/ozone generating system 44 is turned on, the ion generation mode is gradually shifted to the ozone generation mode by gradually raising the supply voltage V1 to the ion/ozone generator 41.

The cellular phone unit 60 in a fordable shape that has been described hereinabove is provided with an enclosure including contact type information input portions, and can freely seal and open a space being adjacent to the contact type information input portions by having the cellular phone unit 60 placed in the folded state and the open state. Additionally, when the cellular phone unit 60 is in the folded state, the ions or the ozone can be fed (guided) to the sealed space.

Therefore, when the space being adjacent to the contact type information input portions is sealed, sterilization and the like can be performed efficiently by guiding the ions or the ozone to the space; and when the cellular phone unit 60 is opened, a user can easily input information by way of the contact type information input portions.

Moreover, the above-mentioned fordable cellular phone unit comprises an upper enclosure 73 that includes an upper enclosure surface 76; a lower enclosure 74 that includes a lower enclosure surface 77; and a hinge portion that connects the upper enclosure 73 and the lower enclosure 74 to be rotatable. By this rotation, the cellular phone unit can be fordable with the upper enclosure surface 76 and the lower enclosure surface 77 approximately facing each other.

Furthermore, the contact type information input portions are mounted to a portion that is on the upper enclosure surface 76 or the lower enclosure surface 77, and is held by the upper and the lower enclosures (73 and 74), with the cellular phone unit placed in the folded state. At the same time, the ions or the ozone is fed (guided) to a space that is held by both upper and lower enclosures, with the cellular phone unit in the folded state.

Therefore, since the ions or the ozone is guided to the space that is held by both upper and lower enclosures, with the cellular phone unit in the folded state, (at least having more sealing effect than a completely open space due to separation by the two enclosures), removal of dusts or sterilization and bacteria elimination can be performed efficiently for the contact type information input portions.

Moreover, when the cellular phone unit is folded, a sealed space is formed in a portion that is held by the upper and the lower enclosures. At the same time, the contact type information input portions are mounted to a position that is adjacent to the sealed space, and the ions or the ozone is fed to the sealed space.

Therefore, when the cellular phone unit is folded, the contact type information input portions come to contact with the sealed space, and the ions or the ozone is guided to this space, whereby removal of dusts or sterilization and bacteria elimination can be performed more efficiently for the contact type information input portions.

Furthermore, the sealed space is formed, by having the upper enclosure surface 76 and the lower enclosure surface 77 serve as bottom surfaces, and having the shock mitigating member 72 made of rubber material and the hinge mechanism 71 (or only the shock mitigating member 72 when the shock mitigating member 72 is shaped in a gate) serve as side surfaces. Since the shock mitigating member is made of rubber material as described hereinabove, sealing effect in the sealed space is favorable, whereby it is possible to prevent the upper and the lower enclosures from coming into contact and getting damaged when the cellular phone unit is folded.

As shown in FIG. 13, the finger mark sensor 64 is mounted to a position that is opposite to the ion ejecting portion 69 when the cellular phone unit is folded. Therefore, by utilizing a force of eject, it is possible to have the ions or the ozone come to contact with the finger mark sensor 64 more efficiently. As for a location at which removal of dusts or sterilization and bacteria elimination are especially asked for, such as the finger mark sensor 64, it is a good method to arrange the finger mark sensor 64 so as to face toward an ion ejection outlet.

Next, the configuration and function of each portion of the cellular phone unit 60 will be described hereinafter. However, as for items that have already been described, overlapped description will be omitted.

The operation keys 61 comprise a plurality of push-button input keys indicating numbers and alphabetic letters. The position selection key 65 comprises, what is called, a cross-shaped push-button key that indicates four directions, up and down and right to left. An operator inputs information (a telephone number and the like) being necessary for operation of the cellular phone unit 60 by way of the operation keys 61, by using the position selection key 65.

The main display portion 62 is a display unit for displaying an image information that the cellular phone unit 60 has. The above-mentioned image information is, for example, an image information that is transmitted externally and received by the cellular phone unit 60, an image information that is obtained by image sensing being performed by the image sensing portion 75, or an image information of a function menu and the like of the cellular phone unit 60.

The sub-display portion 63 supplements the display function of the main display portion 62. The sub-display portion 63, for example, has a time and a calendar displayed when the cellular phone unit 60 is folded and in the standby sate for an incoming call, and has a caller's telephone number and e-mail address displayed when a call is received. In order to reduce power consumption, generally, the display of the sub-display portion 63 is darker than that of the main display portion 62; and such a control is performed as the display operation is stopped, and the like when a predetermined time has passed since the sub-display portion 63 starts displaying.

In addition, various kinds of display units, such as liquid crystal display devices, plasma display devices, light emitting diode display devices, and the like, can be employed as the main display portion 62 and the sub-display portion 63. However, from a viewpoint of low power consumption and miniaturization, it is desirable to employ liquid crystal display devices.

The finger mark sensor 64 comprises a solid-state image sensing device such as a charge coupled devices (CCD) imager, a complementary metal oxide semiconductor (CMOS) imager and the like; an element to read a change in capacitance; and the like, and reads out a finger mark of an operator who touches the finger mark sensor 64. The finger mark sensor 64 is for identifying the operator by, what is called, biometric certification so as to maintain security in operation. To be specific, only when a finger mark being read by the finger mark sensor 64 coincides with a finger mark being registered (the operator's finger mark), a specific function of the cellular phone unit 60 can be available.

Moreover, in reading out the finger mark by the finger mark sensor 64, a temperature of a portion which a finger including the finger mark touches (for example, a surface temperature of the finger mark sensor 64) may be measured. Then, when the temperature is out of a specific range, the result of the identification will be cancelled whatever the result of verification of the finger mark is. (To be specific, use of the above-mentioned specific function is not permitted.). As a result, it is possible to prevent “masquerading” by obtaining a pattern of a registrant's finger mark so as to counterfeit the finger mark, or “masquerading” by using the registrant's finger being cut-off.

The ion generation operation mode setting key 66 is a key for performing a series of operations to have the cellular phone unit 60 function as an ion generating device. First, by depressing the ion generation operation mode setting key 66, the cellular phone unit 60 is set to be in an operation mode to function as an ion generating device. To be concrete, the ion generator 70 starts operation, thereby ejecting the ions or the ozone from the ion ejecting portion 69. Next, when the ion generation operation mode setting key 66 is depressed, the ion generator 70 stops operation, thereby stopping the ejection of the ions or the ozone from the ion ejecting portion 69.

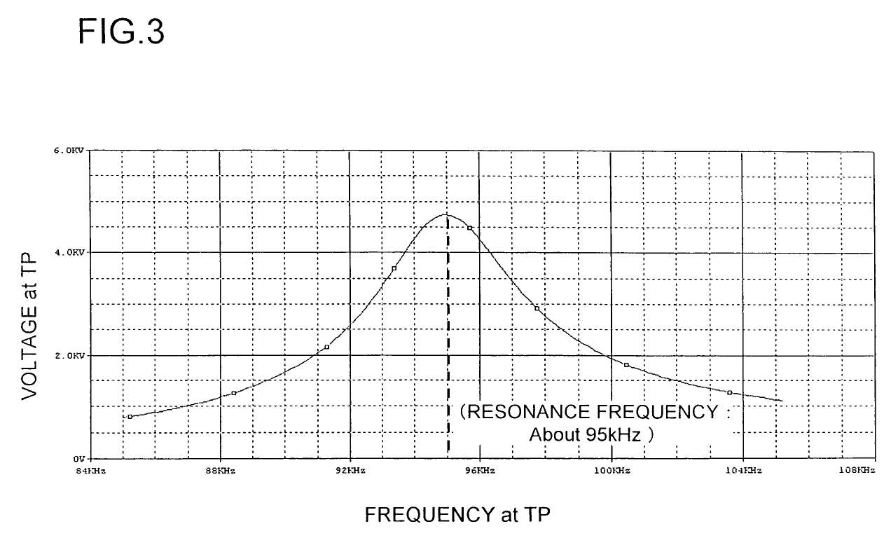

The ion generation voltage raising key 67 and the ion generation voltage lowering key 68 are keys for adjusting the maximum voltage at an absolute value of a high voltage to be applied to the ion generating elements 5 (See FIG. 3 and the like.) within a pressure-resistance range of components constructing the ion generator 70. To be concrete, when the ion generation voltage raising key 67 is depressed, by raising the above-mentioned voltage V1 in proportion to the number of depressing actions in an area where the ozone is not generated, the above-mentioned maximum voltage is raised; and when the ion generation voltage lowering key 68 is depressed, the above-mentioned maximum voltage is lowered by having the above-mentioned voltage V1 decreased in proportion to the number of depressing actions. When the above-mentioned maximum voltage is set to be low, the amount of the ion generation is decreased, but power consumption is restrained.

The image sensing portion 75 receives an optical imagery displaying an object of image sensing by way of a lens (being not illustrated) so as to be fed to an internal circuit by converting the optical imagery into an electric signal, thereby functioning as a so-called digital camera. Image information (image data) being obtained by image sensing performed by the image sensing portion 75 is recorded in the memory portion 83 so as to be re-used, when necessary.

A wireless communication portion 82 (See FIG. 15.) is for wireless communication with other cellular phone units and the like by way of radio waves at an external base station and the like. The wireless communication portion 82 receives. and transmits the radio waves by way of an antenna 81. The memory portion 83 memorizes information being obtained by wireless communication, a control program being housed in the cellular phone unit 60 in advance, information being fed by the contact type information input portions such as the operation keys 61 and the like. A voice input-output portion 84 is a portion to receive and feed voices for communication.

A cellular phone unit is described as one example of an electronic apparatus in accordance with the fourth embodiment. However, the ion generators in accordance with the first to third embodiments can be applied to various electronic apparatuses (especially, to portable electronic apparatuses). Especially, due to characteristics such as a low price, a light weight, and a high reliability (a high impact resistance), the ion generator in accordance with the present invention is suitable for small mobile electronic apparatuses. The content being disclosed in the description about the fourth embodiment is applicable to various electronic apparatuses, such as electronic thermometer units, heating cookers (microwaves and the like), and the like, and due to this applicability, can be achieved an effective sterilizing effect that contributes to maintenance of hygiene.

### Fifth Embodiment

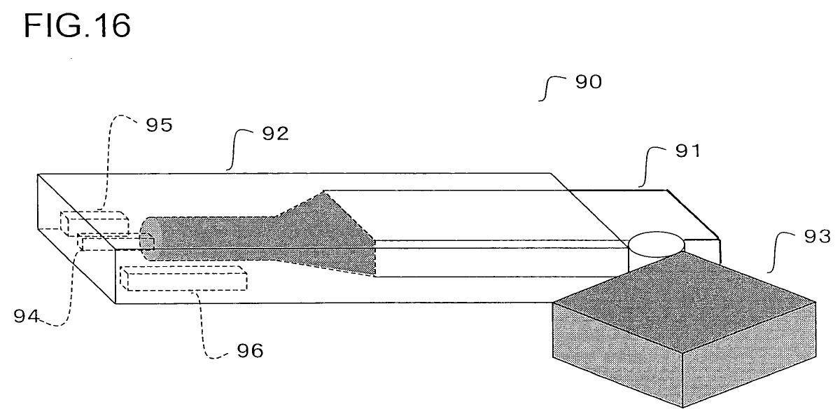

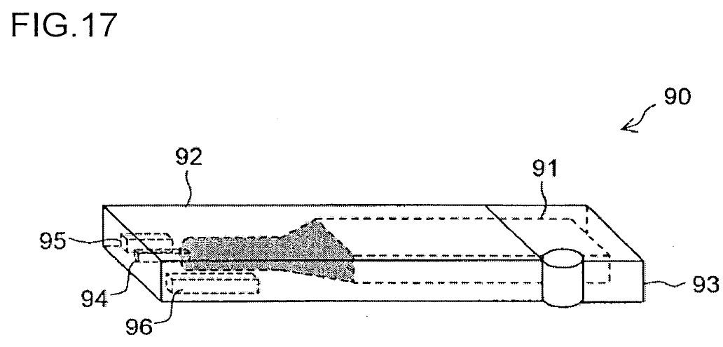

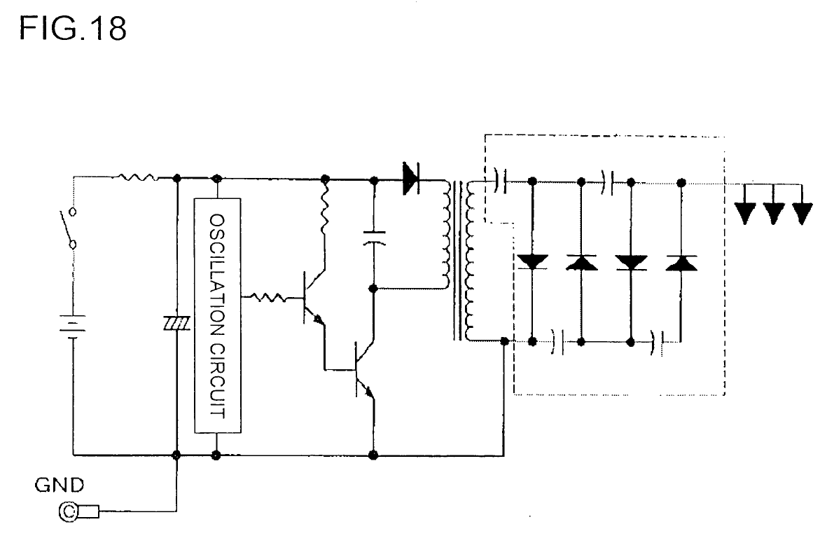

A fifth embodiment will be described hereinafter as an example when an ion generator in accordance with the present invention is applied to a thermometer unit. FIG. 16 and FIG. 17 are perspective vies showing a thermometer unit 90 in accordance with the present embodiment. FIG. 16 shows a state in which a lid 93 of a thermometer container is opened, while FIG. 17 shows a state in which the lid 93 is closed.

The thermometer unit 90 comprises a thermometer body 91 for measuring a body temperature, a thermometer container body 92, a thermometer container lid 93, a storage detecting sensor 94, a high voltage output device 95, and ion generating elements 96. The thermometer container body 92 and the lid 93 construct a thermometer container for storing the thermometer body 91. Inside the thermometer container body 92 are installed the storage detecting sensor 94, the high voltage output device 95 and the ion generating elements 96.

The thermometer container body 92 is shaped in a box, having a space saved for storing the thermometer body 91 therein, and having one surface opened. The lid 93 is also shaped in a box, having a space saved for storing the thermometer body 91 therein, and having one surface opened. By engaging the surfaces of the thermometer container body 92 and the lid 93 that are opened, as shown in FIG. 17 (to be specific, by having the lid 93 closed), the thermometer body 91 can be stored inside a space being formed by the thermometer container body 92 and the lid 93, in a condition to be approximately shut off from the ambient air.

The above-mentioned space being formed by the thermometer container body 92 and the lid 93 by closing the lid will be referred as a “thermometer storing space” hereinafter. The thermometer storing space is sealed by closing the lid, and is opened to the ambient air by opening the lid (to be specific, disengaging the thermometer container body 92 and the lid 93).

When the lid 93 is closed with the thermometer body 91 inserted into the thermometer container body 92, one surface of the thermometer body 91 is pressed to the lid 93, whereby another surface of the thermometer body 91 supplies pressure to the storage detecting sensor 94. The storage detecting sensor 94 is pressed in by the pressure so as to turn on a switch (being not illustrated) between a battery (being not illustrated) being housed in the thermometer container body 92 and the high voltage output device 95. To be specific, an output voltage of the above-mentioned battery is supplied to the high voltage output device 95 as a voltage of the power source.

The high voltage output device 95 and the ion generating elements 96 construct any of the ion generators in accordance with the first through the third embodiments (including an ion/ozone generator hereinafter), wherein the high voltage output device 95 is equivalent to the ion generators that have the ion generating elements 5 excluded. The ion generating elements 96 are same as any of the ion generating elements 5 in accordance with the first through the third embodiments. When an output voltage of the above-mentioned battery is fed to the high voltage output device 95, the ion generator comprising the high voltage output device 95 and the ion generating elements 96 is turned on, and thereby, an alternate current high voltage is produced from the high voltage output device 95. The alternate current high voltage is applied to the ion generating elements 96, whereby the ions and/or the ozone is produced from the ion generating elements 96.

For example, when an ion generator comprising the high voltage output device 95 and the ion generating elements 96 is the ion generator in accordance with the first embodiment, the ions are produced from the ion generating elements 96. When the ion generator comprising the high voltage output device 95 and the ion generating elements 96 is the ion generator in accordance with the second embodiment, the ions and/or the ozonse is produced from the ion generating elements 96.

Products (the ions and/or the ozone) that are produced from the ion generating elements 96 are fed to the inside of the thermometer storing space. Since the thermometer storing space is sealed, the above-mentioned products fill the interior of the thermometer storing space in which the thermometer body 91 is stored, whereby sterilization and the like are performed efficiently.

When the lid 93 is opened, the operation of the high voltage output device 95 is turned off by having the supply of a voltage from the above-mentioned battery shut off, whereby the generation of the above-mentioned products stops.

While there have been described herein what are to be considered preferred embodiments of the present invention, other modifications and variations of the invention are possible to be practiced, provided all such modifications fall within the spirit and scope of the invention.

Especially, in accordance with the fourth and the fifth embodiments, such ion generator can be employed as includes various circuit configurations of public knowledge. To be specific, for example, an ion generator, including a high voltage output device of public knowledge that can obtain necessary high voltages for the ion generation by employing a piezoelectric transformer, a charge pump, and the like, can be applied as the ion generator 70. However, considering cost performance, lightweight properties, reliability and the like, it is preferable to adopt any of the ion generators in accordance with the first through the third embodiments as an ion generator.

According to a high voltage output device in accordance with the present embodiment whose embodiments have been described hereinabove, it is possible to practically offer a high voltage output device of high efficiency that can follow fluctuations even when a resonance frequency on the secondary side of the transformer fluctuates (for example, due to fluctuations in the load capacity on the secondary side of the transformer). To be specific, it is possible to reduce a difference (deviation) between a voltage being fed from the primary side of the transformer and the resonance frequency on the secondary side of the transformer as much as possible.

As a result, is fed back an alternate current signal of a resonance frequency component that is determined by an inductance and a load capacity on the secondary side of the transformer, which means, to be specific, an alternate current signal (an alternate current voltage) having a frequency at which a voltage being applied to the load is at maximum. Therefore, an oscillation circuit system can oscillate at a frequency at which the voltage being applied to the load is at maximum, so that a maximum output voltage can be obtained by following a fluctuation in the load capacity even though the load capacity fluctuates, and thereby, high efficiency can be achieved.

What is claimed is:

1. A high voltage output device comprising a transformer that amplifies a voltage being fed to a primary side coil thereof so as to be produced from a secondary side coil thereof,
in which an alternate current input voltage is fed to the primary side coil and an output voltage is produced from the secondary side coil; further comprises:
a feedback circuit that feeds back the output voltage; and
a voltage amplifying circuit that amplifies the voltage being fed back so as to be produced to the primary coil are provided.

2. A high voltage output device as described in claim 1:
wherein, when a resonance circuit is formed by having a capacitive load connected to the secondary side coil, an oscillation circuit, which has a resonance frequency in the resonance circuit serve as an oscillation frequency, is formed by a closed circuit including the transformer, the feedback circuit, and the voltage amplifying circuit.

3. A high voltage output device as described in Claim I:.
wherein, the feedback circuit includes a voltage lowering circuit that lowers the output voltage, and feeds back a voltage being lowered by the voltage lowering circuit; and
wherein, the voltage lowering circuit lowers the output voltage so as to be within a range of a permissible input voltage of the voltage amplifying circuit.

4. A high voltage output device as described in claim 3:
wherein, the voltage lowering circuit includes a first resistance element and a second resistance element; and
wherein, the voltage lower circuit lowers the output voltage, by dividing a voltage between both terminals of the secondary coil by using the first resistance element and the second resistance element.

5. A high voltage output device as described in claim 3:
wherein, the voltage lowering circuit includes a first capacitive element and a second capacitive element, and
wherein, the voltage lowering circuit lowers the output voltage by dividing a voltage between both terminals of the secondary side coil by using the first capacitive element and the second capacitive element.

6. A high voltage output device as described in claim 3:
wherein, the voltage lowering circuit comprises substrate patterns that are formed on a substrate;
wherein, the substrate patterns are mounted so as to include a first capacitive portion and a second capacitive portion that produce electric capacities with the substrate patterns serving as both electrodes; and
wherein, the voltage lowering circuit lowers the output voltage, by dividing a voltage between both terminals of the secondary side coil by using the first capacitive portion and the second capacitive portion.

7. A high voltage output device as described in claim 6:
wherein the first capacitive portion is formed by a capacitive coupling of a first pattern and a second pattern that are among the substrate patterns; and
wherein, the first pattern and the second pattern are mounted onto a same surface of the substrate.

8. A high voltage output device as described in claim 6:
wherein, the first capacitive portion is formed by a capacitive coupling of a first pattern and a second pattern that are among the substrate patterns; and
wherein, the first pattern and the second pattern are mounted onto surfaces being opposite to each other in the substrate.

9. A high voltage output device as described in claim 7 or claim 8:
wherein, the first patterns is connected to a secondary side of the transformer, and
wherein, the second pattern is connected to the voltage amplifying circuit.

10. A high voltage output device as described in claim 7 or claim 8:
wherein, the first pattern or the second pattern has a part thereof cut off; and
wherein, by connecting both parts being cut off each other, a capacity of the first capacitive portion fluctuates.

11. A high voltage output device as described in claim 6:
wherein, the second capacitive portion is formed by a capacitive coupling of any of the substrate patterns and a ground pattern in the substrate.

12. A high voltage output device as described in claim 2:
wherein, the oscillation circuit is a self-excited oscillation circuit that actuates with a noise voltage, being generated by initiation of an electric power to the voltage amplifying circuit, serving as a starting point; and
wherein a noise voltage amplifying portion that amplifies the noise voltage is provided.

13. A high voltage output device comprising:
a transformer that amplifies a voltage being fed to a primary side coil thereof so as to be produced from a secondary side coil thereof,
in which an alternate input voltage is fed to the primary side coil, and an output voltage is produced from the secondary side coil; further comprises:
a feedback circuit that feeds back the output voltage; and
an alternate current signal producing medium that produces an alternate current signal, having a frequency corresponding to the voltage being fed back, so as to be fed to the primary side coil.

14. A high voltage output device as described in claim 13:
wherein, when a resonance circuit is formed by having a capacitive load connected to the secondary side coil, the alternate current signal producing medium detects a resonance frequency of the resonance circuit, based on the voltage being fed back; and
wherein an alternate current voltage having a same frequency of the resonance frequency being detected is produced as the alternate current signal.

15. A high voltage output device as described in claim 14:
wherein, the alternate current signal producing medium comprising:
a first pulse producing portion that produces a single pulse signal;
a waveform shaping portion that digitizes the voltage being fed back;
a frequency measuring portion that measures a frequency of the digitized voltage;
a frequency memory portion that memorizes the measured frequency;
a second pulse producing portion that produces a pulse signal having a same frequency as the memorized frequency; and
a switch that connects one of the first pulse producing portion and the second pulse producing portion to the primary side coil so as to be switchable;
wherein, the alternate current signal serves as the pulse signal.

16. A high voltage output device as described in claim 15:
wherein, the feedback circuit is provided with a rectifying element; and
wherein, the output voltage is fed back to the alternate current signal producing medium after being rectified by the rectifying element.

17. A high voltage output device as described in claim 15:
wherein, the feedback circuit includes a bias addition circuit that adds a predetermined bias voltage to the voltage being fed back.

18. A high voltage output device as described in claim 17:
wherein, the bias voltage is produced by having a voltage being supplied from a power source line divided by a plurality of resistance elements.

19. A high voltage output device as described in claim 13:
wherein, the feedback circuit includes a voltage lowering circuit that lowers the output voltage, and
wherein, the feed back circuit feeds back a voltage being lowered by the voltage lowering circuit.

20. A high voltage output device as described in claim 19:
wherein, the voltage lowering circuit includes a first resistance element and a second resistance element; and
wherein, the voltage lowering circuit lowers the output voltage by dividing a voltage between both terminals of the secondary side coil by using the first resistance element and the second resistance element.

21. A high voltage output device as described in claim 19:
wherein, the voltage lowering circuit includes a first capacitive element and a second capacitive element; and
wherein, the voltage lowering circuit lowers the output voltage by dividing a voltage between both terminals of the secondary side coil by using the first capacitive element and the second capacitive element.

22. A high voltage output device as described in claim 19:
wherein, the voltage lowering circuit comprises substrate patterns being formed on a substrate;
wherein, the substrate patterns are arranged so as to include a first capacitive portion and a second capacitive portion that are portions to produce electric capacitances, having the substrate patterns serve as both electrodes; and
wherein, the voltage lowering circuit lowers the output voltage by dividing a voltage between both terminals of the secondary side coil by using the first capacitive portion and the second capacitive portion.

23. A high voltage output device as described in claim 22:
wherein, the first capacitive portion is formed by a capacitive coupling of a first pattern and a second pattern that are any of the substrate patterns; and
wherein, the first pattern and the second pattern are mounted on a same surface in the substrate.

24. A high voltage output device as described in claim 22:
wherein, the first capacitive portion is formed by a capacitive coupling of a first pattern and a second pattern that are any of the substrate patterns; and
wherein, the first pattern and the second pattern are mounted on surfaces being opposite to each other in the substrate.

25. A high voltage output device as described in claim 23 or claim 24:
wherein, the first pattern is connected to a secondary side coil of the transformer; and
wherein, the second pattern is connected to the voltage amplifying circuit.

26. A high voltage output device as described in claim 23 or claim 24:
wherein, the first pattern or the second pattern has a part thereof cut off; and
wherein, by having the parts being cut off connected to each other, a capacity of the first capacitive portion fluctuates.

27. A high voltage output device as described in claim 22:
wherein, the second capacitive portion is formed by a capacitive coupling of any of the substrate patterns and a ground pattern in the substrate.

28. An ion generator including a high voltage output device as described in claim 1 comprising:
an ion generating element that generates ions and/or ozone from air by employing an output voltage of the high voltage output device.

29. An ion generator including a high voltage output device as described in claim 1 comprising:
ion generating elements that generate ions and/or ozone from air by employing an output voltage of the high voltage output device;
a changing-over portion that changes over a voltage amplification ratio in the voltage amplifying circuit; and
a control medium that controls a state of generation of ions and/or ozone in the ion generating elements by changing over the output voltage through a change in the voltage amplification ratio.

30. An ion generator including a high voltage output device as described in claim 13 comprising:
ion generating elements that generate ions and/or ozone from air by employing an output voltage of the high voltage output device;
a changing-over portion that changes over a level of the alternate current signal; and,
a control medium that controls a state of generation of ions and/or ozone in the ion generating elements by changing over the output voltage through a change in a level of the alternate current signal.

31. An ion generator including a high voltage output device as described in claim 29 or claim 30:
wherein ions and ozone are generated;
wherein, a control state setting medium to set a state of control in the control portion by alternatively selecting from at least four operation modes is provided; and
wherein, the four operation modes comprise:
a first operation mode that generates ions without generating ozone;
a second operation mode that generates less ozone than a predetermined amount;
a third operation mode that generates more ozone than the predetermined amount; and,
a fourth operation mode that generates neither ions nor ozone.

32. An electronic apparatus including an ion generator as described in claim 28:
wherein, an ion guiding medium is provided to guide ions and/or ozone being generated by the ion generator so as to come to contact with a part or a whole of the electronic apparatus.

33. An electronic apparatus as described in claim 32 comprising:
contact type information input portions for a person to input information by direct contacting therewith;
wherein, the ion guiding medium guides the ions and/or the ozone to the contact type information input portions.

34. An electronic apparatus as described in claim 33:
wherein, the contact type information input portions include either a device to which biometric information is fed, or a key for key operation.

35. An electronic apparatus as described in claim 33 comprising:
an enclosure including the contact type information input portions;
wherein, the enclosure is configured so as to have a space being adjacent to the contact type information input portions sealed or opened freely; and
wherein, the ion guiding medium guides the ions and/or the ozone to the space when the space is sealed.

36. An electronic apparatus as described in claim 33 comprising:
a first enclosure that includes a first external surface;
a second enclosure that includes a second external surface; and
a hinge portion that connects the first enclosure and the second enclosure so as to be rotatable;
which can be folded by the rotating action so as to have the first external surface and the second external surface approximately face each other;
wherein, the contact type information input portions are mounted to a portion that is on the first external surface or on the second external surface, and is held by the two enclosures in the folded state; and
wherein, the ion guiding medium guides the ions and/or the ozone to a space that is held by the two enclosures in the folded state.

37. An electronic apparatus as described in claim 36:
wherein, in the folded state, an approximately sealed space is formed in a portion that is held by the two enclosures;
wherein, the contact type information input portions are provided to a position being adjacent to the approximately sealed space; and
wherein, the ion guiding medium guides ions and/or ozone to the approximately sealed space.

38. An electronic apparatus as described in claim 37:
wherein, the first external surface and the second external surface are provided with a protruding portion of rubber material; and
wherein, the approximately sealed space is formed, by having the first external surface and the second external surface serve as both bottom surfaces thereof, and having the protruding portion and/or the hinge serve as side surfaces thereof.

39. An electronic apparatus as described in claim 36:
wherein, the ion guiding medium includes an ion ejection outlet that ejects the ions and/or ozone to the first external surface; and
wherein, the contact type information input portions are provided to a position on the second external surface, facing to the ion ejection outlet, in the folded state.

40. A container comprising:
an ion generator as described in claim 28; and
having an object stored inside thereof in approximately sealed condition;
wherein, ions and/or ozone that is generated from the ion generator is fed to the inside.

41. A thermometer unit comprising:
a thermometer, and
a container as described in claim 40 for storing the thermometer inside thereof.

42. A voltage output device comprising:
a transformer that amplifies a voltage being fed to a primary side coil thereof so as to produced from a secondary side coil thereof;
a load connecting portion which a capacitive load is connected to so as to form an LC resonance circuit with the secondary side coil;
a voltage output portion that feeds an alternate current voltage to the primary side coil;
a feedback circuit that feeds back a voltage, being produced by the LC resonance circuit, to the voltage output portion;
wherein, the voltage output portion detects a resonance frequency of the resonance circuit based on the voltage being fed back, and
feeds an alternate current voltage having the resonance frequency to the primary side coil.
